(19) United States
(12) Patent Application Publication
(10) Pub. No.: US 2025/0112488 A1
(43) Pub. Date: Apr. 3, 2025

(54) AC POWER DELIVERY FOR REDUCED CORROSION

(71) Applicant: Apple Inc., Cupertino, CA (US)

(72) Inventors: Albert Wang, Sunnyvale, CA (US); Todd S. Mintz, San Jose, CA (US); Benjamin Morse, San Jose, CA (US); Christopher S. Graham, San Francisco, CA (US); Eric X. Zhou, Mountain View, CA (US); Karl Ruben Fredrik Larsson, Scotts Valley, CA (US); Nicholas S. Brodine, Los Gatos, CA (US)

(73) Assignee: Apple Inc., Cupertino, CA (US)

(21) Appl. No.: 18/896,299

(22) Filed: Sep. 25, 2024

Related U.S. Application Data
(60) Provisional application No. 63/541,726, filed on Sep. 29, 2023.

(51) Int. Cl. H02J 7/00; H02J 7/04

(52) U.S. Cl. CPC H02J 7/007182; H02J 7/0042; H02J 7/04

(57) ABSTRACT

Electric fields that can cause corrosion of contacts can be compensated for by embodiments of the present invention. For example, voltage waveforms at the contacts can be made to have a zero volt average, and therefore have a zero net electric field. Galvanic voltages generated by dissimilar metals used by a contact and a housing can generate an electric field, and currents motivated by the galvanic electric field can be blocked by capacitively coupling the contacts to their corresponding circuits.

### CROSS-REFERENCES TO RELATED APPLICATIONS

This application claims the benefit of U.S. Provisional Application No. 63/541,726, filed on Sep. 29, 2023, which is incorporated by reference.

### BACKGROUND

The amount of data transferred between electronic devices has grown tremendously the last several years. Large amounts of audio, streaming video, text, and other types of data content are now regularly transferred among desktop and portable computers, media devices, handheld media devices, displays, storage devices, and other types of electronic devices.

Power and data can be provided from one electronic device to another over cables that can include one or more wire conductors, fiber optic cables, or other conductors. Connector inserts can be located at each end of these cables and can be inserted into connector receptacles in the communicating or power transferring electronic devices. Contacts in or on a connector insert can form electrical connections with corresponding contacts in a connector receptacle. Other devices can have contacts at a surface of a device. Pathways for power and data can be formed when devices are attached or positioned next to each other and corresponding contacts are electrically connected to each other.

These various contacts in connector inserts, in connector receptacles, or on a surface of a device, can be exposed to the local environment. These contacts can encounter liquid, moisture, or other damaging contaminants. For example, liquids can be spilled on these contacts or a device can be set down such that its contacts land in a puddle of liquid. Users can swim or exercise while wearing or holding an electric device. These activities can put contacts for the electronic devices in a position to encounter various contaminants.

These liquids or other contaminants can corrode and damage the contacts. This corrosion can be greatly exacerbated by the presence of an electric field, such as when a constant or DC voltage is applied to a contact. The result is that power contacts can be particularly susceptible to corrosion.

Thus, what is needed are methods, structures, and apparatus that are able to deliver power through device contacts while minimizing their corrosion.

### SUMMARY

Accordingly, embodiments of the present invention can provide methods, structures, and apparatus that are able to deliver power through a pair of power contacts while minimizing their corrosion. An illustrative embodiment of the present invention can provide methods, structures, and apparatus that are able to deliver power through a pair of power contacts while minimizing corrosion by delivering power using a differential alternating voltage that has an average voltage of (or near) zero volts. These and other embodiments of the present invention can prevent current flow that can result from galvanic voltages by capacitively coupling the power contacts to circuitry in an electronic device.

Contacts on electronic devices can be exposed to corrosive materials and fluids. These corrosive materials and fluids can induce corrosion of the contacts thereby releasing ions from the contacts. In the presence of a DC electric field, the corrosion and release of ions can be accelerated. By applying an alternating electric field, the net corrosion of the contacts can be reduced. By applying an alternating electric field with a voltage that has an average value of, or near, zero volts, the migration of ions out of a contact can be at least approximately equal to the migration of ions into of the contact. This symmetrical migration can reduce corrosion of the contact. The effectiveness of this can be reduced by galvanic voltages that can be present between a first metal forming a contact and a second metal forming a housing or enclosure for the electronic device. This galvanic voltage can generate an electric field that can also cause corrosion. A galvanic voltage can provide current flow through a contact, through circuitry in the electronic device, to the housing or enclosure, which can be grounded. The electron flow of this current can balance the migration of ions in a liquid. This current can be interrupted by capacitively coupling the power contacts to circuitry in an electronic device. That is, the capacitor can act as a direct current (DC) block that can block the DC component of the current motivated by the galvanic voltage, further reducing corrosion of the power contacts.

Various contacting structures can be used in these and other embodiments of the present invention. First contacts on a first device can mate with second contacts on a second device. The first contacts can be spring biased to provide a contacting force, while the second contacts can be fixed to a device enclosure and can be acted on by the contacting force of the first contacts. The first contacts can be biased by a pair of canted coil springs. The canted coil springs can be positioned in a housing such that their central axis are orthogonal to a connection direction of the first contact. When the first device and the second device are mated, the first contact can be pushed in a direction into the first device. The first contact can push a plate and a holder into the canted coil springs, thereby collapsing or flattening the diameter of the canted coil springs. The distorted canted coil springs can then provide a deflection force into the second contact. When the first device and the second device are disconnected, the canted coil springs can revert to their original shape, pushing the first contact away from the first device. Motion of the first contact can be limited by attaching the first contact and pins to the holder, where the pins can move in corresponding slots in a housing in the first device. The canted coil springs can be held in position using one or more pins located through the center axis of the canted coil springs.

In these and other embodiments of the present invention, the first contacts can be biased by a single canted coil spring. The canted coil spring can be positioned in a housing such that its central axis is orthogonal to a connection direction of the first contact. When the first device and the second device are mated, the first contact can be pushed in a direction into the first device. The first contact can push a plate and a holder into the canted coil spring, thereby collapsing or flattening the diameter of the canted coil spring. The distorted canted coil springs can then provide a deflection force into the second contact. When the first device and the second device are disconnected, the canted coil spring can revert to its original shape, pushing the first contact away from the first device. Motion of the first contact can be limited by attaching a pin to the holder, where the pin can move in slot in a housing in the first device. The canted coil spring can be held in position using a number of slats attached to a frame.

In these and other embodiments of the present invention, the first contacts can be biased by one or more stacks of Bellville washers. The Bellville washers can be placed back-to-back and then stacked. The stack can be placed on an alignment pin to limit the motion of the Bellville washers. When the first device and the second device are mated, the first contact can be pushed in a direction into the first device. The first contact can push a plate into the Bellville washers. As the plate is pushed into the stack of Bellville washers, the Bellville washers can compress, thereby reducing the length of the stack of the Bellville washers. The Bellville washers can have the same or different thicknesses such that the Bellville washers provide an at least somewhat constant force over the deflection of the first contact. When the first device and the second device are disconnected, the Bellville washers can revert to their original shape, pushing the first contact away from the first device. The first contact and the plate can be attached to a holder. Motion of the first contact can be limited by attaching a pin to the holder, where the pin can move in a slot in a housing in the first device.

In these and other embodiments of the present invention, the second contacts can be fixed in the second device and a first contact can provide a force against a second contact. The second contact can be supported by a housing that is sealed to a housing or enclosure of the second device by a sealing ring. The contact and housing can be attached to a flex using a pressure-sensitive or other adhesive. The flex can be held in place by a cowling. The cowling can be attached to the flex using a pressure-sensitive or other adhesive. The cowling can be fastened to the housing or enclosure of the second device.

Various circuits can be used to transfer power in these and other embodiments of the present invention. These circuits can be used to transfer power from the first device to the second device, from the second device to the first device, or power can be transferred bidirectionally or in a back-and-forth manner between the first device and the second device. For example, the first device can receive power from a charger or power adapter. While the first device is being powered, the second device can be connected to the first device. This can allow the first device to provide power to the second device. During device operation, the second device can provide power back to the first device. During device operation, the first device can continue to provide power to the second device as needed.

These power circuits can be the same or substantially similar in the first device and the second device. In these and other embodiments of the present invention, the first device and the second device can have differences, for example where the transfers of power between the first and second device are unidirectional or one-way.

These and other embodiments of the present invention can provide a power transfer circuit having a battery. A first power transfer circuit can be housed in the first device while a second power transfer circuit can be housed in the second device. The battery can be connected to power circuits in the first device. The battery can be connected to a switch, with can be opened when the first device is disconnected from the second device and closed when power is being transferred. The switch can in turn be connected to boost/buck circuit, which can be connected to an inverter/rectifier circuit. The inverter/rectifier circuit can provide capacitively coupled output signals to a pair of first contacts. The capacitively coupled output signals can be received from the pair of first contacts by a pair of second contacts of the second device. A rectifier/inverter circuit, which can be the same as, or similar to, the inverter/rectifier circuit of the first device, can receive the output signals and provide an output to a buck/boost circuit, which can be the same as, or similar to, the boost/buck circuit in the first electronic device. The buck/boost circuit can be coupled through a switch to a battery and internal circuits of the second device.

Power can be transferred from the first device to the second device. In the first power transfer circuit, the switch can connect the battery to the boost/buck circuit. The boost/buck circuit can act as a boost to increase the voltage from the battery and provide a high voltage and a low voltage to the inverter/rectifier circuit. The inverter/rectifier circuit can operate as an inverter to provide a differential output signal. The differential output signal can be capacitively coupled to a pair of first contacts of the first device.

The differential output signal can be received by a pair of second contacts of the second device. The differential output signal can be capacitively coupled to the rectifier/inverter circuit, which can convert the differential output signal to a high voltage and a low voltage. The high voltage and a low voltage can be stepped down by the buck/boost circuit, which can provide power through the switch to charge the battery of the second device. While power is described as being transferred from the first device to the second device, power can be transferred from the second device to the first device as well.

Various output differential signals can be provided by inverter circuits consistent with embodiments of the present invention. For example, sinewaves that are antiphase (or 180 degrees out of phase) can be provided on pairs of first contacts or pairs of second contacts. Square-waves that are antiphase can be provided on pairs of first contacts or pairs of second contacts. Square-waves that have been filtered to remove high-frequency components and are antiphase can be provided on pairs of first contacts or pairs of second contacts. Square-waves that are bandwidth limited and are antiphase can be provided on pairs of first contacts or pairs of second contacts. Other differential waveforms can be provided on pairs of first contacts or pairs of second contacts.

The frequency of the differential output signals can be varied. The amplitude of the differential output signals can be varied. These parameters can be varied as various conditions for the pairs of first contacts or pairs of second contacts vary. For example, when liquid is detected on one or more contacts, the frequency, amplitude, or both, can be varied for the differential output signals. The differential output signals can be discontinued under some conditions.

The first contacts in the first device can be capacitively coupled to the first power transfer circuit in the first device and the second contacts in the second device can be capacitively coupled to the second power transfer circuit in the second device. The presence of the capacitors used for this AC or capacitive coupling can break DC current paths among the first contacts, second contacts, an enclosure for the first device, and an enclosure for the second device.

For example, a liquid or fluid can be over some or all of the first contacts, second contacts, an enclosure for the first device, and an enclosure for the second device. As part of an electrochemical corrosion process, the fluid can induce corrosion of one or more of the first contacts, second contacts, enclosure for the first device, or enclosure for the second device, thus releasing ions from the structures into the fluid. The transfer of the ions into the fluid can be part of a loop that includes a galvanic voltage motivating electron migration from a contact and through circuits in either the first device or second device, and then to a grounded housing or enclosure. The input coupling capacitors can block the DC component of this current, thereby breaking the loop and slowing ions from flowing out of the contact and into the fluid.

In short, the presence of an electric field can cause ions to transfer from a contact into a liquid. This process can corrode the contact. Accordingly, electric fields can be compensated for by embodiments of the present invention. For example, voltage waveforms at the contacts can be made to have a zero volt average, and therefore have a zero net electric field. Also, galvanic voltages generated by dissimilar metals used by a contact and a housing can generate an electric field, but currents motivated by the galvanic electric field can be blocked by capacitively coupling the contacts to their corresponding circuits.

Data can be transferred between the first device and the second device in various ways. The amplitude of the differential output signal can be modulated with data. The phase of the differential output signal can be modulated with data. The frequency of the differential output signal can be modulated with data. These modulations can be applied by a power and data transmitting device and recovered by a power and data receiving device. In these and other embodiments of the present invention, a power transmitting device can provide a differential output signal. A power receiving device can be a data transmitting device and can modulate a load seen by the power transmitting device. The load can be modulated by data that the power receiving device sends back to the power transmitting device. The power transmitting device can also be the data receiving device and can recover the data.

These and other embodiments of the present invention can include additional features that can help to prevent or reduce corrosion. For example, electro-impedance spectrography circuits can be included. These circuits can provide a voltage waveform to one or more contacts of a device. A resulting voltage, a resulting current, or both can be measured. A resulting current can indicate that current is flowing through a liquid. A phase shift between the applied voltage waveform and either the resulting current or the resulting voltage can indicate an amount a type of liquid. Coupling capacitors can be inserted between the contacts and the electro-impedance spectrography circuits to prevent a corrosion path.

Embodiments of the present invention can provide power transfer circuits and apparatus that can be located in various types of devices, such as portable computing devices, tablet computers, desktop computers, laptops, all-in-one computers, wearable computing devices, cell phones, smart phones, media phones, storage devices, portable media players, navigation systems, monitors, power supplies, video delivery systems, adapters, remote control devices, chargers, and other devices.

The first device and the second device can be various types of devices. While the first device and the second device can be connected through a cable, they are often mated directly together. For example, the first device can be an audio device, such as headphones or earbuds, while the second device can be a case for carrying and charging the audio device, or the second device can be an audio device, such as headphones or earbuds, while the first device can be a case for carrying and charging the audio device. The first device can be a tablet computer, while the second device can be a case and keyboard, or the second device can be a tablet computer, while the first device can be a case and keyboard. The first device can be a watch, while second can be a watchband, or the second device can be a watch, while the first device can be a watchband. The first device and the second device can be other types of devices that can connect to each other by directly mating.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates an electronic system according to an embodiment of the present invention;

FIG. 2 illustrates a spring-biased contact assembly according to an embodiment of the present invention;

FIG. 3 illustrates a spring-biased contact assembly according to an embodiment of the present invention;

FIG. 4 is an exploded view of the contact assembly of FIG. 3;

FIG. 5 illustrates a force-deflection curve for a first contact according to an embodiment of the present invention;

FIG. 6 illustrates a variation on a spring-biased contact assembly according to an embodiment of the present invention;

FIG. 7 is an exploded view of the contact assembly of FIG. 6;

FIG. 8 is a cross-section of a second contact assembly according to an embodiment of the present invention;

FIG. 9 is an exploded view of the contact assembly of FIG. 8;

FIG. 10 is a block diagram of a charging system for the electronic system of FIG. 1 according to an embodiment of the present invention;

FIG. 11 is a circuit diagram of a contact interface for the electronic system of FIG. 1 according to an embodiment of the present invention;

FIG. 12 is a simplified circuit diagram of a portion of a power system circuit according to an embodiment of the present invention;

FIG. 13 is an alternative simplified circuit diagram of a portion of a power system circuit according to an embodiment of the present invention;

FIG. 14 is a simplified circuit diagram of portions of two power system circuits transferring power according to an embodiment of the present invention;

FIG. 15 through FIG. 17 illustrate contact assemblies according to an embodiment of the present invention;

FIG. 18A through FIG. 18D illustrates profiles of contact assemblies according to an embodiment of the present invention;

FIG. 19 illustrates contact assemblies for a contact interface according to an embodiment of the present invention;

FIG. 20 illustrates further details of a contact assembly according to an embodiment of the present invention;

FIG. 21 illustrates contact assemblies for a contact interface according to an embodiment of the present invention;

FIG. 22 is a cutaway side view of a contact assembly according to an embodiment of the present invention;

FIG. 23 illustrates galvanic corrosion paths in electronic devices according to embodiments of the present invention;

FIG. 24 illustrates optional DC charging in electronic devices according to an embodiment of the present invention;

FIG. 25 illustrates an AC waveform for power transfers according to an embodiment of the present invention;

FIG. 26 illustrates a charging path through an electronic system according to an embodiment of the present invention;

FIG. 27 illustrates another charging path through an electronic system according to an embodiment of the present invention;

FIG. 28 illustrates another charging path through an electronic system according to an embodiment of the present invention;

FIG. 29 illustrates data that can be used by a method of determining a type of material used for a contact according to an embodiment of the present invention; and

FIG. 30 illustrates a method of optimizing a charging waveform according to an embodiment of the present invention.

### DESCRIPTION OF ILLUSTRATIVE EMBODIMENTS

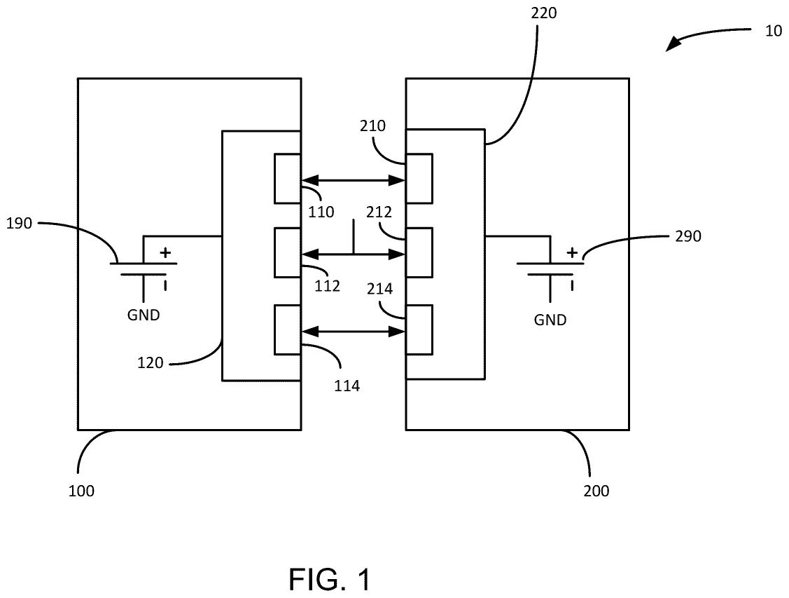

FIG. 1 illustrates an electronic system according to an embodiment of the present invention. This figure, as with the other included figures, is shown for illustrative purposes and does not limit either the possible embodiments of the present invention or the claims.

In this example, electronic system 10 can include first device 100 that can be connected to second device 200 in order to share data, power, or both. First contact 110, first contact 112, and first contact 114 (collectively first contacts 110) on first device 100 can be electrically connected to second contact 210, second contact 212, and second contact 214 (collectively second contacts 210) on second device 200. First contacts 110 on first device 100 can be electrically connected to contacts second contacts 210 on second device 200 using a cable (not shown.) In other embodiments of the present invention, first contacts 110 on first device 100 can be directly and electrically connected to second contacts 210 on second device 200. In various embodiments of the present invention, first contacts 110 and second contacts 210 can be power contacts or other types of contacts. Examples of embodiments of the present invention where first contact 110, first contact 112, second contact 210, and second contact 212 are power contacts are shown in the following figures. First contact 114 and second contact 214 can be ground contacts, data or signal contacts, or other types of contacts.

Embodiments of the present invention can transfer power from first device 100 to second device 200 by providing an alternating differential voltage having an average value at or near zero volts at first contact 110 and first contact 112. Power can be transferred from second device 200 to first device 100 by providing an alternating differential voltage having an average value at or near zero volts at second contact 210 and second contact 212. This can provide a reduced or low level of ion migration into the contact, thereby reducing corrosion of first contacts 110 and second contacts 210 when the device power contact is exposed to contaminants. First contacts 110 can be capacitively coupled to power transfer circuit 120 and second contacts 210 can be capacitively coupled to power transfer circuit 220. The capacitive coupling can eliminate or reduce currents generated by galvanic voltages between dissimilar metals used for first contacts 110, second contacts 210, and enclosure or housing for first device 100 and second device 200.

First contacts 110 can be coupled to power transfer circuit 120 in first device 100. Power transfer circuit 120 can provide power to or draw power from battery 190. Second contacts 210 can be coupled to power transfer circuit 220 in second device 200. Power transfer circuit 220 can provide power to or draw power from battery 290.

First device 100 and second device 200 can be various types of devices. While first device 100 and second device 200 can be connected through a cable, they are often mated directly together. For example, first device 100 can be an audio device, such as headphones or earbuds, while second device 200 can be a case for carrying and charging the audio device, or second device 200 can be an audio device, such as headphones or earbuds, while first device 100 can be a case for carrying and charging the audio device. First device 100 can be a tablet computer, while second device 200 can be a case and keyboard, or second device 200 can be a tablet computer, while first device 100 can be a case and keyboard. First device 100 can be a watch, while second device 200 can be a watchband, or second device 200 can be a watch, while first device 100 can be a watchband. First device 100 and second device 200 can be other types of devices that can connect to each other by directly mating.

First contacts 110 can be spring-biased contacts that can mate with fixed second contacts 210. First contacts 110 can be spring biased such that they provide a force against second contacts 210 to provide a good electrical connection. Examples of first contacts are shown in the following figures.

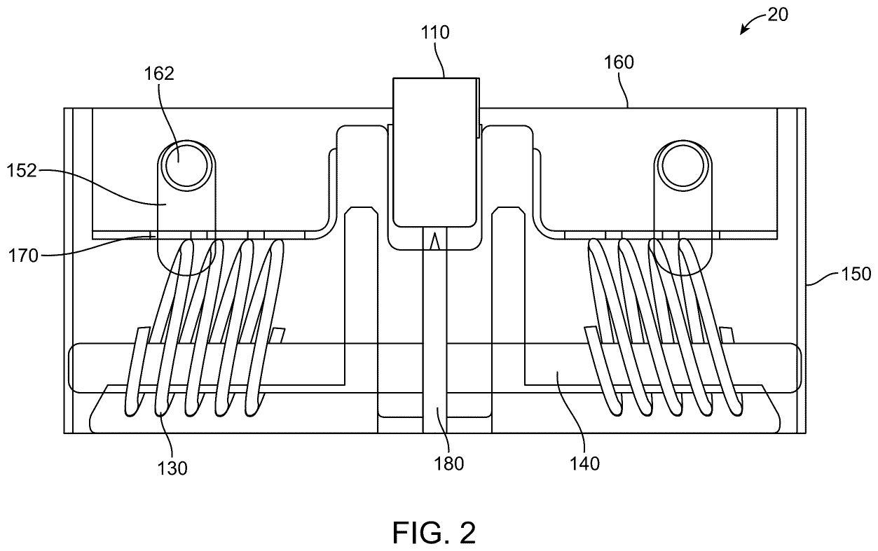

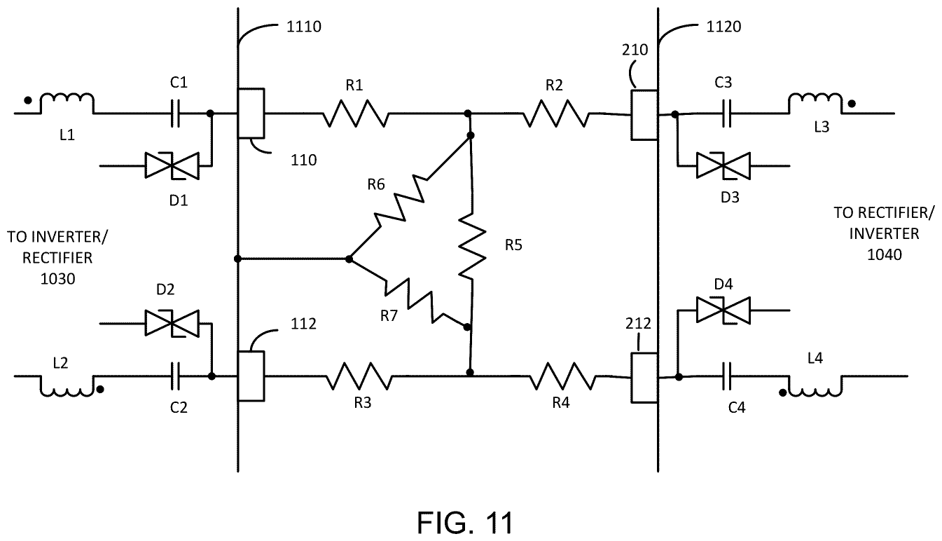

FIG. 2 illustrates a spring-biased contact assembly according to an embodiment of the present invention. First contact assembly 20 can include first contact 110. First contact 110 can be biased by a pair of canted coil springs 130. Canted coil springs 130 can be positioned in housing 150 such that the central axes of canted coil springs 130 are orthogonal to a connection direction of first contact 110. When first device 100 and the second device 200 (both shown in FIG. 1) are mated, first contact 110 can be pushed in a direction into first device 100. First contact 110 can push plate 170 and holder 160 into canted coil springs 130, thereby collapsing or flattening canted coil springs 130 in the direction of their diameters. When first device 100 and second device 200 are disconnected, canted coil spring 130 can revert to their original shape, pushing first contact 110, plate 170, and holder 160 away from first device 100. The motion of first contact 110 can be limited by attaching the first contact and pins 162 to holder 160, where pins 162 can move in slots 152 in housing 150 in first device 100. Canted coil springs 130 can be held in position using one or pins 140 located through the center axis of canted coil springs 130. Wire 180 can couple first contact 110 to a coupling capacitor, such as coupling capacitor C1 in FIG. 11.

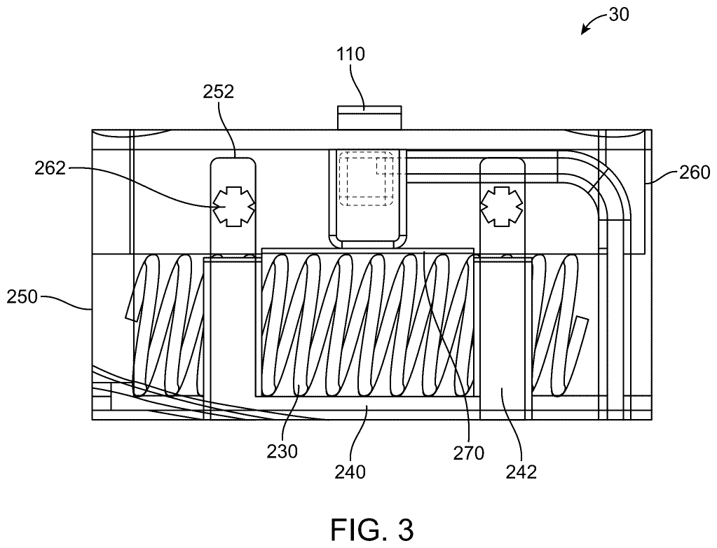

FIG. 3 illustrates a spring-biased contact assembly according to an embodiment of the present invention. In these and other embodiments of the present invention, first contact 110 can be biased by single canted coil spring 230. First contact assembly 30 can include canted coil spring 230. Canted coil spring 230 can be positioned in housing 250 such that its central axes are orthogonal to a connection direction of first contact 110. When first device 100 and second device 200 (both shown in FIG. 1) are mated, first contact 110 can be pushed in a direction into first device 100. First contact 110 can push plate 270 and holder 260 into canted coil spring 230, thereby collapsing or flattening canted coil spring 230 in its diameter direction. When first device 100 and second device 200 are disconnected, canted coil spring 230 can revert to its original shape, pushing first contact 110, plate 270, and holder 260 away from first device 100. The motion of first contact 110 can be limited by attaching first contact 110 and pins 262 to holder 260, where pins 262 can move in slots 252 in housing 250 in first device 100. Canted coil spring 130 can be held in position using a number of slats 242 attached to frame 240. Wire 280 can couple first contact 110 to a coupling capacitor, such as coupling capacitor C1 in FIG. 11.

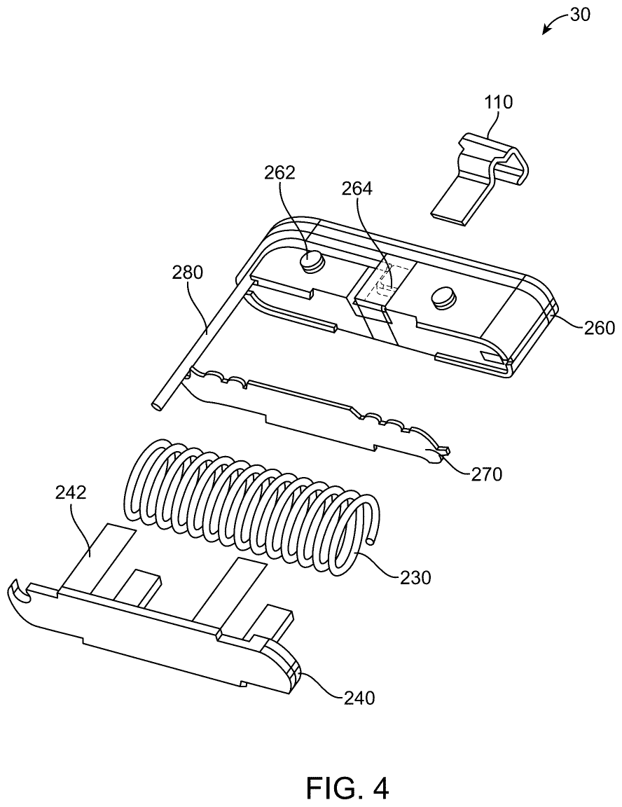

FIG. 4 is an exploded view of the contact assembly of FIG. 3. First contact assembly 30 can include canted coil spring 230. Canted coil spring 230 can be held in place by slats 242 extending from frame 240. Plate 270 can further confine canted coil spring 230. Plate 270 can attach to a bottom of holder 260. Holder 620 can hold first contact 110 in slot 264. Plate 270 can be attached to an underside of holder 260. Wire 280 can route voltages and currents from first contact 110 to power transfer circuit 120 in first device 100. Holder 260 can slide through a range defined by pins 262 in slots 252 in housing 250 (shown in FIG. 3.) When first device 100 and the second device 200 (both shown in FIG. 1) are mated, first contact 110 can be pushed in a direction into first device 100. First contact 110 can push plate 170 and holder 160 into canted coil springs 130, thereby collapsing or flattening canted coil springs 130 in its diameter direction. When first device 100 and second device 200 are disconnected, canted coil spring 130 can revert to its original shape, pushing plate 270, holder 260, and first contact away 110 from first device 100.

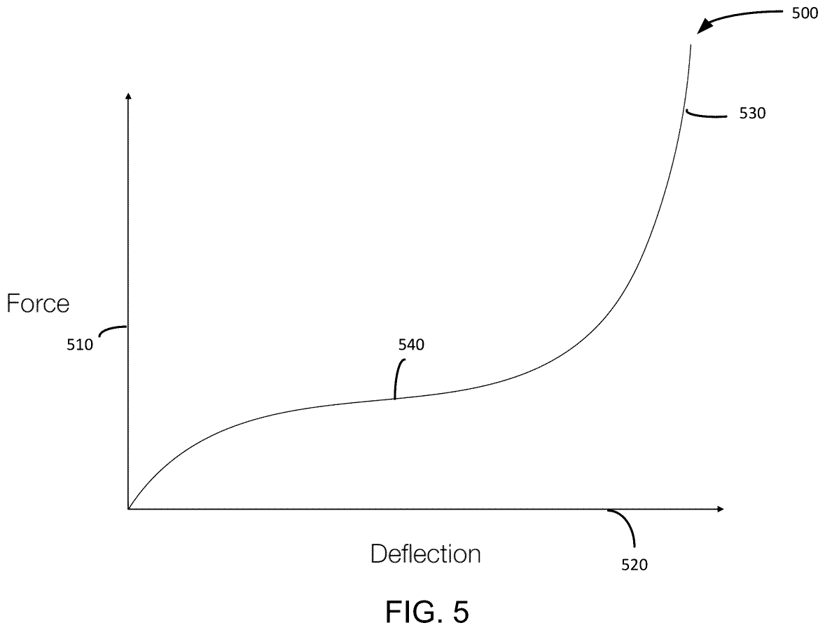

FIG. 5 illustrates a force-deflection curve for a first contact according to an embodiment of the present invention. Graph 500 illustrates a force-deflection curve 530 plotted as the contacting force 510 provided by a first contact 110 (shown in FIG. 1) as a function of the deflection 520 of the first contact. When first device and second device are mated, first contact 110 can be deflected an amount that can be in the range 540. The deflection can vary in the range due to manufacturing tolerances in the formation of first device 100, second device 200, first contacts 110, second contacts 210, as well as the manner in which they are mated. It can therefore be desirable that the contacting force be independent as a function of displacement. That is, it can be desirable that the force-deflection curve 530 be at least relatively flat in the range 540. This can be accomplished using the canted coil springs 130 and canted coil spring 230 in the examples of FIG. 2 and FIG. 3. The force-deflection curve 530 can be given a flat portion in range 540 using other structures. An example is shown in the following figures.

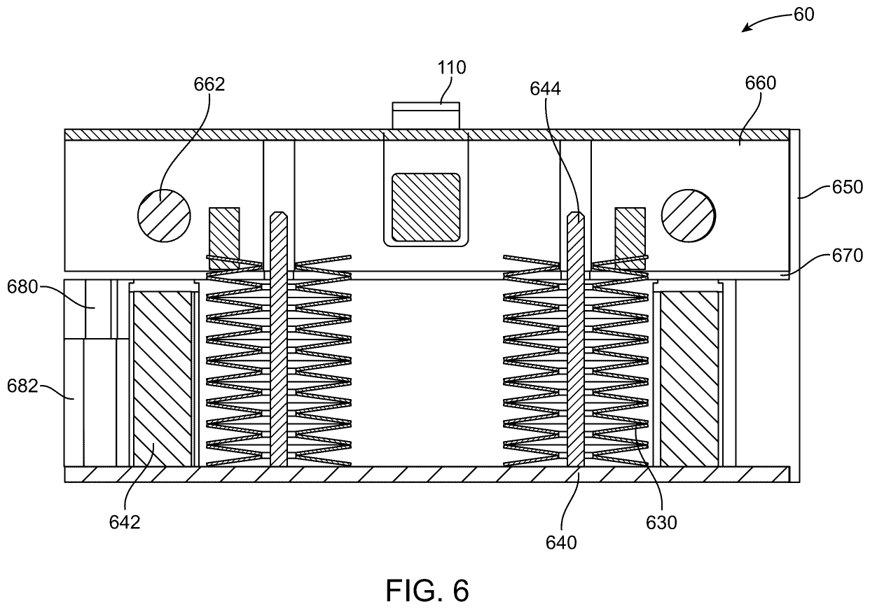

FIG. 6 illustrates a variation on a spring-biased contact assembly according to an embodiment of the present invention. In contact assembly 30, first contacts 110 can be biased by one or more stacks of Bellville washers 630. Bellville washers 630 can be placed back-to-back and then stacked. The stack of Bellville washers 630 can be placed on alignment pin 644 to limit the motion of Bellville washers 630. When first device 100 and second device 200 (both shown in FIG. 1) are mated, first contact 110 can be pushed in a direction into first device 100. First contact 110 can push plate 670 into the Bellville washers 630. As plate 270 is pushed into the stack of Bellville washers 630, Bellville washers 630 can begin compressing, thereby reducing the length of the stack of the Bellville washers 630. Bellville washers 630 can have the same or different thicknesses such that Bellville washers 630 can provide an at least somewhat constant force over the deflection of the first contact 110. When first device 100 and second device 200 are disconnected, Bellville washers 630 can revert to their original shape, pushing first contact 110, holder 660, and plate 670 away from first device 100. Wire 680 can route voltages and currents from first contact 110 to power transfer circuit 120 in first device 100 (all shown in FIG. 1.) Insulation 682 can be provided around wire 680.

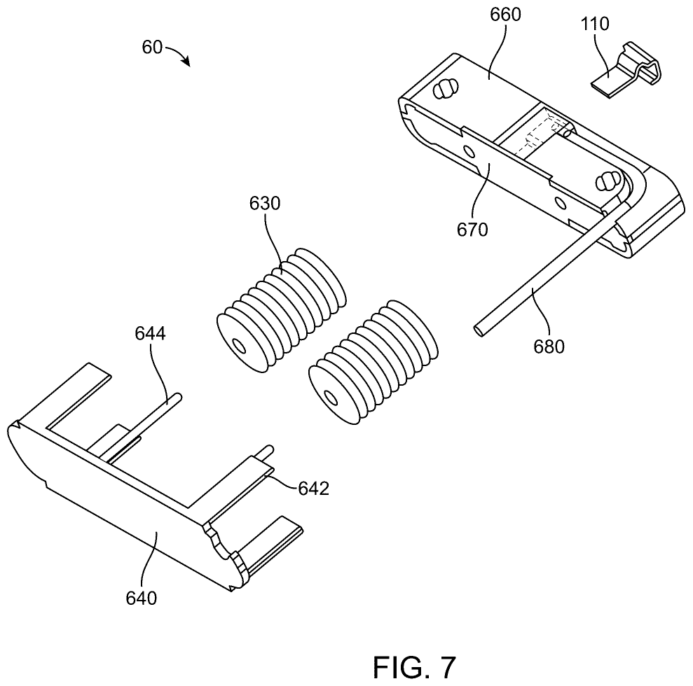

FIG. 7 is an exploded view of the contact assembly of FIG. 6. Stacks of Bellville washers 630 can be placed on alignment pins 644 in contact assembly 30. Bellville washers 630 can be held between frame 640 and plate 670. Slats 642 can extend from frame 640. Wire 680 can route voltages and currents from first contact 110 to power transfer circuit 120 in first device 100 (all shown in FIG. 1.) Holder 660 can support pins 662 (shown in FIG. 6), first contact 110, and plate 670. Holder 660 can move throughout a range defined by pins 662 in openings (not shown) in housing 650.

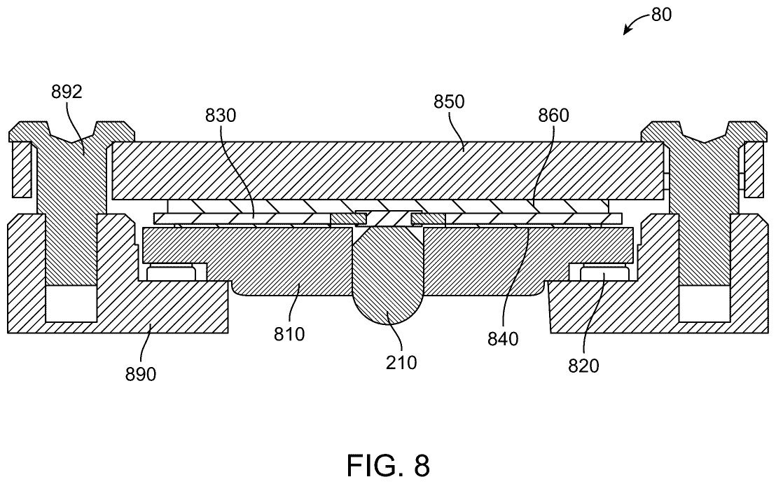

FIG. 8 is a cross-section of a second contact assembly according to an embodiment of the present invention. In these and other embodiments of the present invention, second contacts 210 in second contact assembly 80 can be fixed in second device 200 (shown in FIG. 1) and first contact 110 can provide a force against second contact 210. Second contact 210 can be supported by housing 810 that is sealed to housing or enclosure 890 of second device 200 by sealing ring 820. Second contact 210 can be attached to flexible circuit board 830 using pressure-sensitive adhesive 840 or other adhesive. Flexible circuit board 830 can be held in place by cowling 850. Cowling 850 can be attached to flexible circuit board 830 using pressure-sensitive adhesive 860 or other adhesive. Cowling 850 can be fastened to the housing or enclosure 890 of second device 200 by fasteners 892.

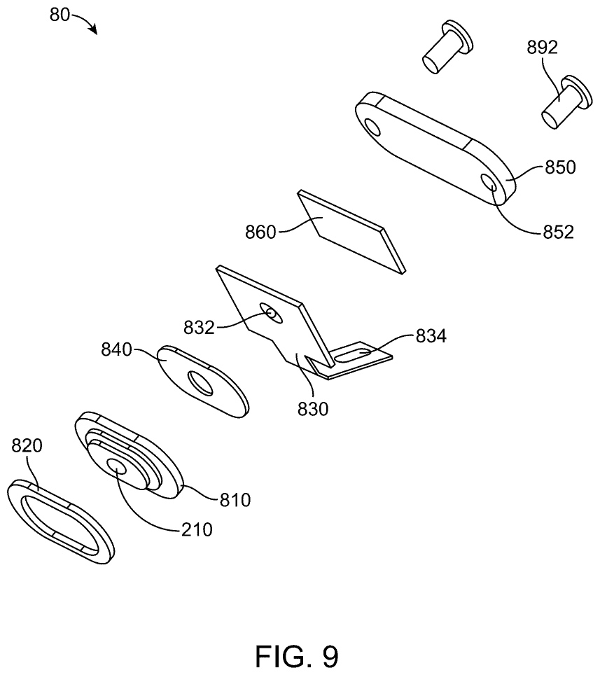

FIG. 9 is an exploded view of the contact assembly of FIG. 8. Second contact 210 in second contact assembly 80 can be supported by housing 810. Housing 810 can be scaled to housing or enclosure 890 (shown in FIG. 8) of second device 200 (shown in FIG. 2) by sealing ring 820. Second contact 210 can make contact with pad 832 on flexible circuit board 830. Flexible circuit board 830 can include pad 834, which can connect to pad 832, for electrically connecting to power transfer circuit 220 (shown in FIG. 1) in second device 200. Housing 810 can be attached to flexible circuit board 830 using pressure-sensitive adhesive 840 or other adhesive. Flexible circuit board 830 can be held in place by cowling 850. Cowling 850 can be attached to flexible circuit board 830 using pressure-sensitive adhesive 860 or other adhesive. Cowling 850 can be fastened to the housing or enclosure 890 of second device 200 by passing fasteners 892 through openings 852 and inserting fasteners 892 in corresponding holes in housing or enclosure 890 of second device 200.

Various circuits can be used to transfer power in these and other embodiments of the present invention. These circuits can be used to transfer power from the first device to the second device, from the second device to the first device, or power can be transferred bidirectionally or in a back-and-forth manner between the first device and the second device. For example, the first device can receive power from a charger or power adapter. While the first device is being powered, the second device can be connected to the first device. This can allow the first device to provide power to the second device. During device operation, the second device can provide power back to the first device. During device operation, the first device can continue to provide power to the second device as needed.

These power circuits can be the same or substantially similar in the first device and the second device. In these and other embodiments of the present invention, the first device and the second device can have differences, for example where the transfers of power between the first and second device are unidirectional or one-way. Examples are shown in the following figures.

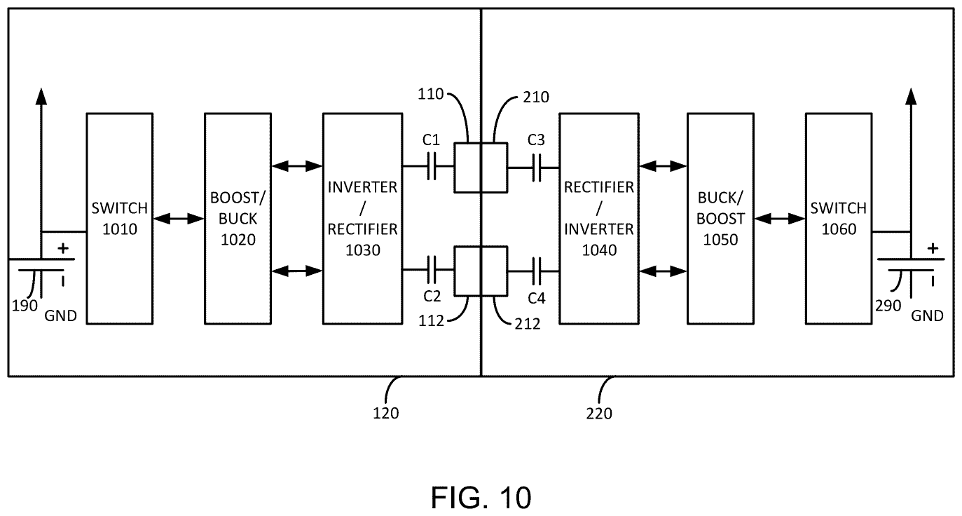

FIG. 10 is a block diagram of a charging system for the electronic system of FIG. 1 according to an embodiment of the present invention. First power transfer circuit 120 can be housed in first device 100 (shown in FIG. 1) while second power transfer circuit 220 can be housed in second device 200 (shown in FIG. 1.) First power transfer circuit 120 can share power with second power transfer circuit 220. For example, power transfer circuit 120 can transfer power to second power transfer circuit 220. Battery 190 can be connected to switch 1010, which can be opened when first device is disconnected from second device 200 and closed when power is being transferred. Switch 1010 can in turn be connected to boost/buck circuit 1020, which can be connected to inverter/rectifier circuit 1030. Inverter/rectifier circuit 1030 can provide capacitively coupled output signals through capacitors C1 and C2 to a pair of first contacts including first contact 110 and first contact 112. The capacitively coupled output signals can be received from the pair of first contacts 110 by a pair of second contacts 210 including second contact 210 and second contact 212 of second device. The signals on second contact 210 and second contact 212 can be capacitively coupled through capacitors C3 and C4 to rectifier/inverter circuit 1040. Rectifier/inverter circuit 1040, which can be the same as, or similar to, inverter/rectifier circuit 1030 of first power transfer circuit 120, can provide an output to buck/boost circuit 1050, which can be the same as, or similar to, boost/buck circuit 1020 in the first power transfer circuit 120. Buck/boost circuit 1050 can be coupled through switch 1060 to battery 290 and internal circuits of second device 200.

Power can be transferred from first device 100 to second device 200. In first power transfer circuit 120, switch 1010 can connect battery 190 to boost/buck circuit 1020. Boost/buck circuit 1020 can act as a boost to increase the voltage from battery 190 and provide a high voltage and a low voltage to inverter/rectifier circuit 1030. Inverter/rectifier circuit 1030 can operate as an inverter to provide a differential output signal. The differential output signal can be capacitively coupled through capacitor C1 to first contact 110 and through capacitor C2 to first contact 112.

The differential output signal can be received by second contact 210 and second contact 212 of second device 200. The differential output signal can be capacitively coupled through capacitors C3 and C4 to rectifier/inverter circuit 1040, which can convert the differential output signal to a high voltage and a low voltage. The high voltage and a low voltage can be stepped down by buck/boost circuit 1050, which can provide power through switch 1060 to charge battery 290 of second device 200. While power is described as being transferred from first device 100 to second device 200, power can be transferred from second device 200 to first device 100 as well.

Various output differential signals can be provided by the inverters of inverter/rectifier circuit 1030 and rectifier/inverter circuit 1040 consistent with embodiments of the present invention. For example, sinewaves that are antiphase (or 180 degrees out of phase with each other) can be provided on pairs of first contacts or pairs of second contacts. Square-waves that are antiphase can be provided on pairs of first contacts or pairs of second contacts. Square-waves that have been filtered to remove high-frequency components and are antiphase can be provided on pairs of first contacts or pairs of second contacts. Square-waves that are bandwidth limited and are antiphase can be provided on pairs of first contacts or pairs of second contacts. Other differential waveforms can be provided on pairs of first contacts or pairs of second contacts.

The frequency of the differential output signals can be varied. The amplitude of the differential output signals can be varied. These parameters can be varied as various conditions for the pairs of first contacts or pairs of second contacts vary. For example, when liquid is detected on one or more contacts, the frequency, amplitude, or both, can be varied for the differential output signals. The differential output signals can be discontinued under some conditions.

Data can be transferred between first device 100 and second device 200 in various ways. The amplitude of the differential output signal can be modulated with data. The phase of the differential output signal can be modulated with data. The frequency of the differential output signal can be modulated with data. These modulations can be applied by a power and data transmitting device and recovered by a power and data receiving device. In these and other embodiments of the present invention, a power transmitting device can provide a differential output signal. A power receiving device can be a data transmitting device and can modulate a load seen by the power transmitting device. The load can be modulated by data that the power receiving device sends back to the power transmitting device. The power transmitting device can also be the data receiving device and can recover the data. Instead of using a differential output signal, data can be transmitted using first contact 114 of first device 100 and second contact 214 of second device 200 (all shown in FIG. 1.)

First contact 110 and first contact 112 in first device 100 can be capacitively coupled to first power transfer circuit 120 in first device 100 using capacitors C1 and C2 and second contact 210 and second contact 212 in second device 200 can be capacitively coupled to second power transfer circuit 220 in second device 200 using capacitors C3 and C4. The presence of the capacitors used for this AC or capacitive coupling can break DC current paths among first contact 110, second contact 210, device enclosure 1110 (shown in FIG. 11) for first device 100, and device enclosure 1120 (shown in FIG. 11) for second device 200.

For example, a fluid or liquid can be over some or all of the first contacts 110, second contacts 210, device enclosure 1110 for first device 100, and device enclosure 1120 for second device 200. As part of an electrochemical corrosion process, the fluid can cause corrosion and induce ions to move out of one or more of first contacts 110, second contacts 210, device enclosure 1110 for first device 100, and device enclosure 1120 for second device 200 and into the fluid. The transfer of the ions out of a contact and into the fluid can be part of a loop that includes current moving from the contact and through circuits in either the first device or second device, and then to ground. The input coupling capacitors can block the DC component of this current, thereby breaking the loop and slowing ions from flowing out of the contact and into the fluid. Further details are shown in the following figure.

FIG. 11 is a circuit diagram of a contact interface for the electronic system of FIG. 1 according to an embodiment of the present invention. First contact 110 can be coupled to electro-static discharge diodes D1. Electro-static discharge diodes D1 can be high-impedance, low-leakage diodes. First contact 110 can be coupled to capacitor C1, which in turn can be coupled to inductor L1. Inductor L1 can be included to reduce an onrush of current through capacitor C1 when first power transfer circuit 120 provides power to second power transfer circuit 220. Capacitor C1 can be chosen to be large enough to provide a low-impedance for the differential output signals but small enough to be physically reasonable. Inductor L1 can be chosen such that the tuned frequency of inductor L1 and capacitor C1 has a period that is shorter than the period of the differential output signals.

Liquid or fluid can become present on one or more of first contact 110, first contact 112, device enclosure 1110, second contact 210, second contact 212, and device enclosure 1120. As part of an electrochemical corrosion process, the fluid can cause corrosion and induce ions to move out of one or more of first contacts 110, second contacts 210, device enclosure 1110, and device enclosure 1210 and into the fluid. The transfer of ions can be facilitated by current flowing from one of the first contacts 110 or second contacts 210 and through circuits in either first device 100 or second device 200, and then to one of device enclosure 1110 or device enclosure 1120, which can be grounded. This current flow can be driven by galvanic voltages that can appear for example, between first contacts 110 and device enclosure 1110. For example, first contacts can be plated with gold or other conductive material, while device enclosure 1110 can be steel, aluminum, or other material. These dissimilar materials can form a galvanic voltage between first contacts 110 and device enclosure 1110. Input coupling capacitors C1 and C2 can block the DC component of this current from one of first contacts 110 to device enclosure 1110. Input coupling capacitors C3 and C4 can block the DC component of current from one of second contacts 210 to device enclosure 1120.

In this example, capacitor C2 can be coupled to first contact 112, electro-static discharge diodes D2, and inductor L2. Inductor L1 and inductor L2 can be coupled to inverter/rectifier circuit 1030. Diodes D1 and D2 can be the same or similar. Inductor L1 and L2 can be the same or similar. Coupling capacitor C3 can be coupled to second contact 210, electro-static discharge diodes D3, and inductor L3. Diodes D1 and D3 can be the same or similar. Inductor L1 and L3 can be the same or similar. Coupling capacitor C4 can be coupled to second contact 212, electro-static discharge diodes D4, and inductor L4. Diodes D1 and D4 can be the same or similar. Inductor L1 and L4 can be the same or similar. Inductor L3 and inductor L4 can be coupled to rectifier/inverter circuit 1040. Stray impedances among first contacts 110, second contacts 210, device enclosure 1110 for first device 100, and device enclosure 1120 for second device 200 can be modeled as resistors R1 through R7. Capacitor C1, capacitor C2, capacitor C3, and capacitor C4 can be the same or similar.

Various circuits can be used to implement power transfer circuit 120 and power transfer circuit 220. Examples are shown in the following figures.

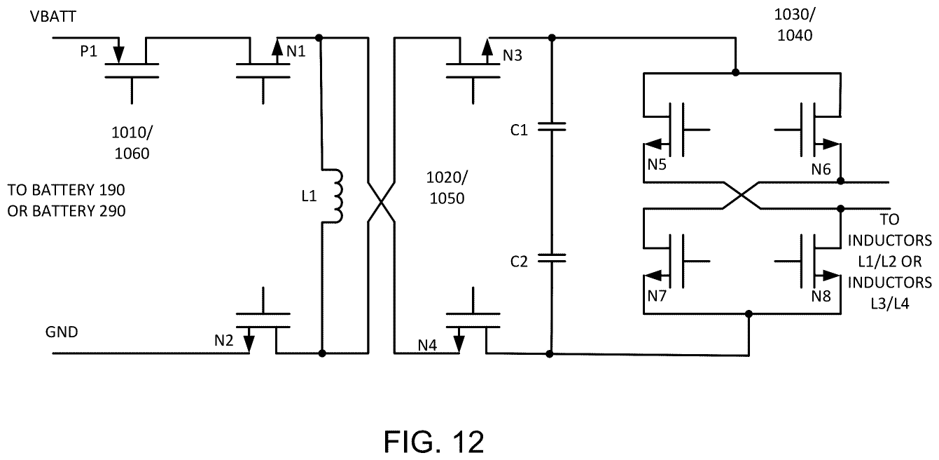

FIG. 12 is a simplified circuit diagram of a portion of a power system circuit according to an embodiment of the present invention. In this example, switch 1010 (and switch 1060) can be implemented using transistor P1. Transistor P1 can connect battery 190 (or battery 290) to boost/buck circuit 1020 (or buck/boost circuit 1050.) Transistor P1 is shown as a P-MOS transistor, though transistor P1 could be implemented in various ways, for example by an N-MOS transistor, by two parallel transistors where a resistor is in series with one of the two, or by other devices or circuits. Boost/buck circuit 1020 (and buck/boost circuit 1050) can be implemented using a single-input multiple-output (SIMO) type architecture that includes inductor L1, transistor N1, transistor N2, transistor N3, and transistor N4. Boost/buck circuit 1020 (or buck/boost circuit 1050) can be coupled to inverter/rectifier circuit 1030 (or rectifier/inverter circuit 1040.) Boost/buck circuit 1020 (and buck/boost circuit 1050) can have a full bridge architecture that can include transistor N5, transistor N6, transistor N7, and transistor N8.

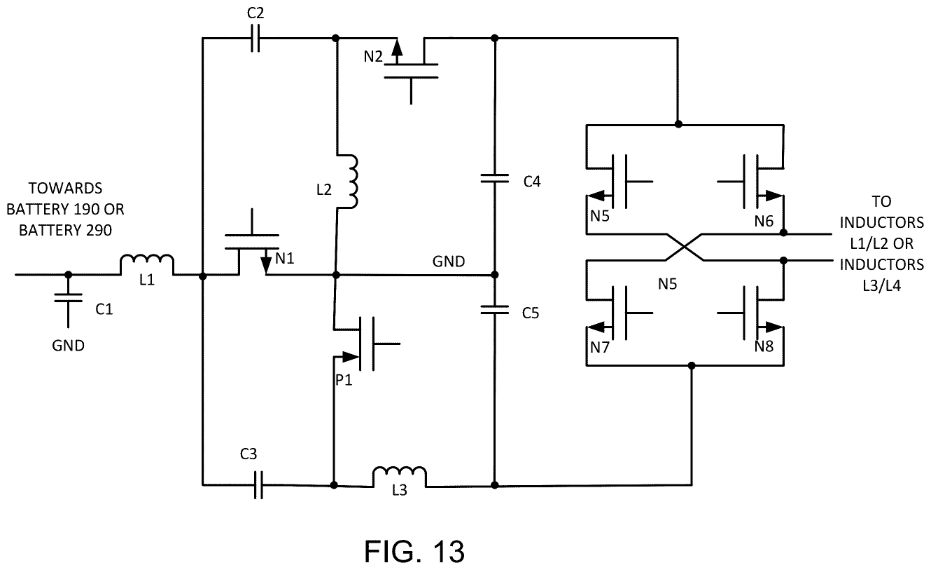

FIG. 13 is an alternative simplified circuit diagram of a portion of a power system circuit according to an embodiment of the present invention. In these and other embodiments of the present invention, such as that shown in FIG. 12, switch 1010 (and switch 1060) can be replaced by a circuit (not shown) that is a voltage and current limiter when receiving power and a current limiter when transmitting data. Boost/buck circuit 1020 (and buck/boost circuit 1050) can be implemented using a SEPIC-Cuk DC-to-DC converter that includes three inductors, inductor L1, inductor L2, and inductor L3. Transistor P1, transistor N1, and transistor N2 can be included, along with capacitor C1, capacitor C2, capacitor C3, capacitor C4, and capacitor C5. Boost/buck circuit 1020 (and buck/boost circuit 1050) can again have a full bridge architecture that can include transistor N5, transistor N6, transistor N7, and transistor N8.

These and other embodiments of the present invention can include additional features that can help to prevent or reduce corrosion. For example, electro-impedance spectrography circuits can be included. These circuits can provide a voltage waveform to one or more contacts of a device. A resulting voltage, a resulting current, or both can be measured. A resulting current can indicate that current is flowing through a liquid. A phase shift between the applied voltage waveform and either the resulting current or the resulting voltage can indicate an amount a type of liquid. Coupling capacitors can be inserted between the contacts and the electro-impedance spectrography circuits to prevent a corrosion path. An example is shown in the following figure.

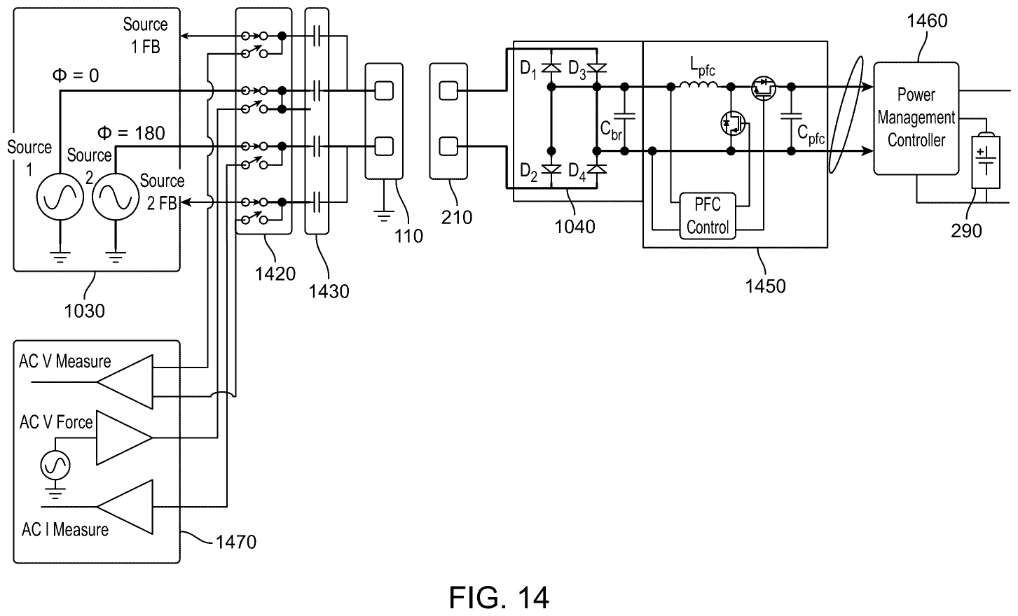

FIG. 14 is a simplified circuit diagram of portions of two power system circuits transferring power according to an embodiment of the present invention. Inverter/rectifier circuit 1030 can act as an inverter and provide a differential output signal though switches 1420 and coupling capacitors 1430 to first contacts 110. Coupling capacitors 1430 can include capacitors C1 and C2 from the contact interface of FIG. 11. Second contacts 210 can receive the differential output signals and provide it to rectifier/inverter circuit 1040, which can act as a rectifier and provide a high voltage and a low voltage to power-factor correction controller 1450. Power-factor correction controller 1450 can pass an output to power management controller 1460, which can charge battery 290. Power management controller 1460 can control a voltage and current seen by battery 290 during charging. This path can be reversed where second device 200 can charge first device 100.

Electrochemical-Impedance Spectroscopy (EIS) circuit 1470 can be included. EIS circuit 1470 can provide a voltage waveform or a current waveform, though in this example a voltage waveform can be provided. The voltage waveform can be a sinewave, square wave, or other voltage waveform. EIS circuit 1470 can be coupled to first contacts 110 through coupling capacitors 1430. When liquid is present at one or more first contacts 110, a current or voltage can be detected using EIS circuit 1470. The current, voltage, or both can indicate a change in capacitance and resistance seen at the first contacts 110. EIS circuit 1470 can detect the magnitude of this current and voltage and any phase shift as compared to the applied voltage, and from that determine a change in capacitance and resistance seen at first contacts 110. From the changes in capacitance and resistance, the presence of liquid and information regarding the type of liquid that is present can be determined. Further details of this can be found in U.S. Pat. No. 11,658,443, issued May 23, 2023, titled LIQUID DETECTION AND CORROSION MITIGATION, which is incorporated by reference. The sources source1 and source2 can be used as the voltage signal in EIS circuit 1470.

Other types of circuits can be included in or associated with either or both power transfer circuit 120 and power transfer circuit 220. For example, a connection detect can be used to disconnect battery 190 or battery 290 when the opposing device is not mated. This connection detect can include sending an occasional voltage ping at first contacts 110. This voltage ping should be of a character where the average value of the ping, or an average value for a set of pings, should be zero volts.

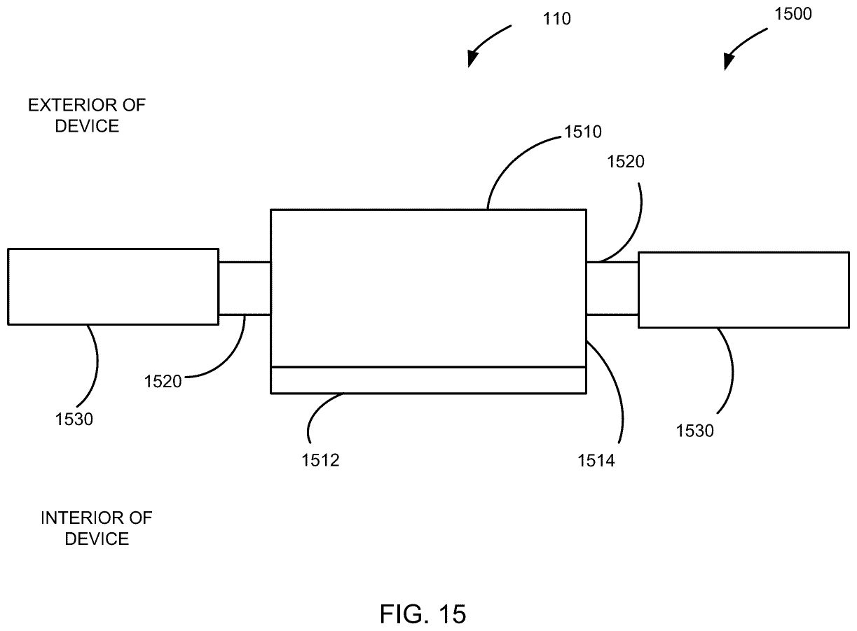

FIG. 15 through FIG. 17 illustrate contact assemblies according to an embodiment of the present invention. In FIG. 15, contact assembly 1500 can include contact 110 and housing 1530. Insulation 1520 can form a seal between contact 110 and housing 1530 to prevent leakage into the interior of the device incorporating contact assembly 1500.

Contact 110 can be formed of bulk or substrate 1510. An optional plating layer 1512 can be formed on a bottom or interior surface of contact 110. Other optional plating can be formed along sides of bulk or substrate 1510. Bulk or substrate 1510 can be formed of stainless steel, titanium, tantalum, inconel, nickel-aluminum bronze, copper, copper alloy, or other material. The use of these materials can provide contacts that can be readily manufactured and can conserve precious resources as compared to contacts that can use exotic materials. These materials can provide good durability and corrosion resistance. Optional plating layer 1512 can be formed of gold or other conductive material, for example optional plating layer 1512 can be a gold flash. Optional plating layer 1512 can form a surface that is solderable to a flexible circuit board or other appropriate substrate.

In these and other embodiments of the present invention, the voltage waveforms conveyed by contacts 110 can be AC waveforms. As such, much of the current through contacts 110 can be conveyed at the surface of contacts 110. Accordingly, embodiments of the present invention can provide plating on some of all of sides 1514 of bulk or substrate 1510. This plating can be gold, diamond-like carbon (which has been formed to be conductive), titanium-nitride, tin-silver, nickel-gold, or other material. In these and other embodiments of the present invention, this plating can extend along a top and some or all of the sides of bulk or substrate 1510. An example is shown in the following figure.

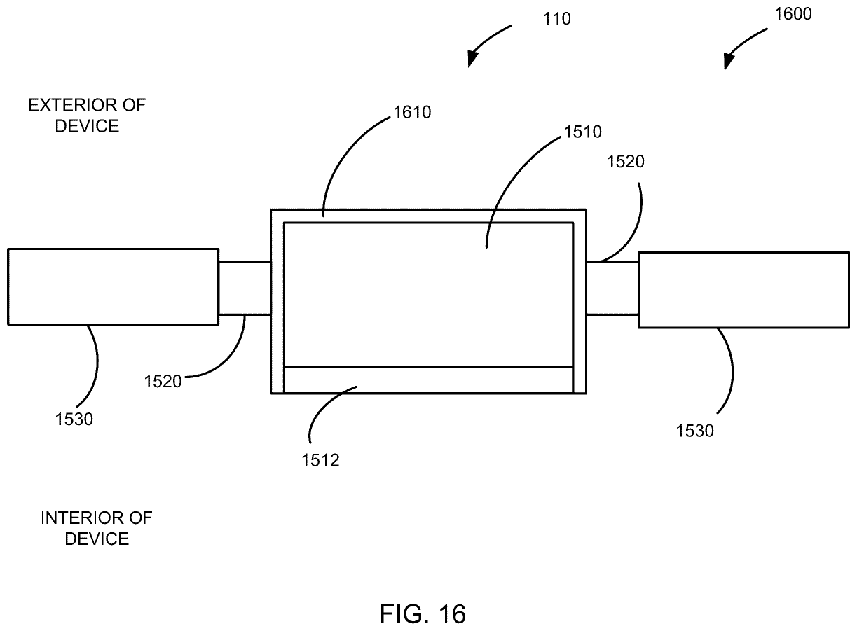

In FIG. 16, contact assembly 1600 can include contact 110, housing 1530, and insulation 1520, which can form a seal between contact 110 and housing 1530. Contact 110 can comprise bulk or substrate 1510 and optional plating layer 1512, which can be plated with finish layer 1610. Finish layer 1610 can be formed of diamond-like carbon (which has been formed to be conductive), tin, tin-silver, nickel-gold, or other material.

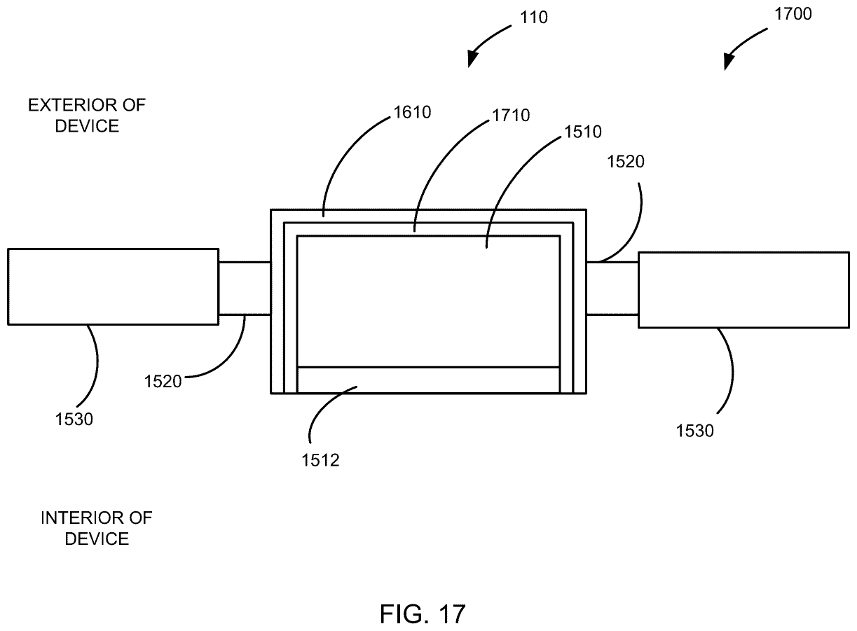

In FIG. 17, contact assembly 1700 can include contact 110, housing 1530, and insulation 1520, which can form a seal between contact 110 and housing 1530. Contact 110 can comprise bulk or substrate 1510, optional plating layer 1512, and finish layer 1610, as well as intermediate layer 1710. With the addition of intermediate layer 1710, the need for bulk or substrate 1510 to conduct the AC waveforms is reduced. This can allow the use of less conductive or nonconductive materials such as plastic, ceramics, ceramic plastics, aluminum, stainless steel, or other materials as the bulk or substrate 1510. Intermediate layer 1710 can be gold, copper, nickel, or a combination of these or other conductive metal. The currents generated by the AC waveforms received by contacts 110 can be conveyed near the surface of contacts 110 due to skin-effects. Accordingly, intermediate layer can be relatively thin, for example 10 to 100 microns, depending on the range of desired frequencies for the AC waveforms. This thickness can allow a good conductivity for the AC waveforms.

The materials and various layers making up contacts 110 can provide at least three functions. They can provide an interface function for mating with another contact, they can provide a conductivity function for conveying a charging AC waveform, and they can provide a mechanical function providing a structure for the contact. In FIG. 15, bulk or substrate 1510 can provide a durable interface for mating with contacts on a second device. The conductivity of bulk or substrate 1510 can be improved by additions of optional plating layer 1512 on a bottom and sides of bulk or substrate 1510. Bulk or substrate 1510 can provide a mechanical function. In FIG. 16, the interface function can be improved with the addition of finish layer 1610. Finish layer 1610 can provide a surface having an improved hardness and corrosion resistance. In FIG. 17, the addition of intermediate layer 1710 affords an opportunity to improve the conductivity function of contact 110 by including a layer of conductive material. Again, the addition of intermediate layer 1710 can remove the necessity of providing conductivity with bulk or substrate 1510. This can allow bulk or substrate 1510 to be formed of a low conductivity or nonconductive material.

These functions can be allocated among these layers in different ways in different embodiments of the present invention. For example, in FIG. 16, finish layer 1610 can have a lower conductivity while bulk or substrate 1510 can have a higher conductivity. In these and other embodiments of the present invention, more than two layers can be plated or otherwise formed over bulk or substrate 1510.

The use of AC waveforms can allow the skin effect to be utilized. That is, skin effect can allow the conductivity of finish layer 1610 and intermediate layer 1710 to be relied upon for charge conduction. Such a reliance on the finish layer 1610 and the intermediate layer 1710 might not be possible when power is transferred using traditional DC voltages and currents.

The use of these plating layers can unfortunately encourage the corrosion of these contacts 110. When a connection is made using a contact 110, the plating layers (such as finish layer 1610 and intermediate layer 1710) and substrate (such as bulk or substrate 1510) can be marred, for example they can be scratched. A galvanic voltage can then appear across the scratch. The presence of an electrolyte can then cause corrosion of contact 110.

Embodiments of the present invention can include various features in order to reduce the galvanic corrosion that can be caused by a scratch on contact 110. For example, materials for the plating and substrate can be selected to reduce any galvanic voltages. As an example, the plating of the contacts can be plated with gold, having a galvanic voltage range of 0.07 to 0.2V, while the bulk or substrate can be titanium, having a galvanic voltage range of −0.12 to 0.04V. Alternatively, the bulk or substrate can be a nonconductive material, such as ceramic, plastic, or a combination of these or other materials.

Along with reducing galvanic voltages at a scratch, embodiments of the present invention can contact assemblies that can minimize the opportunity for such scratches and other types of marring to occur. Examples are shown in the following figure.

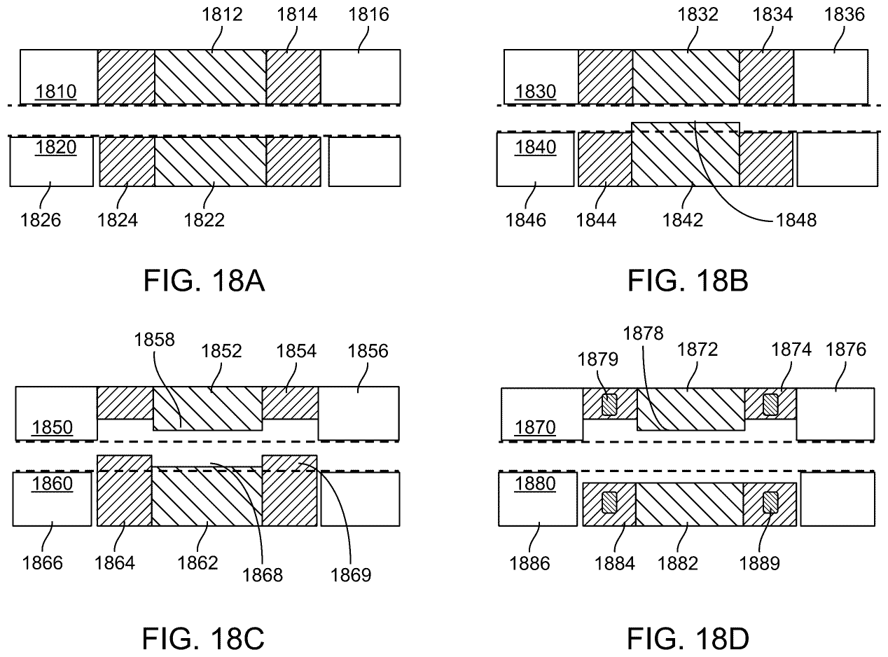

FIG. 18A through FIG. 18D illustrates profiles of contact assemblies according to an embodiment of the present invention. In FIG. 18A, a first device can include contact assembly 1810, which can include contact 1812 surrounded by adjacent insulation 1814 and housing 1816. A second device can include contact assembly 1820, which can include contact 1822 surrounded by adjacent insulation 1824 and housing 1826. In this example, contact 1812, insulation 1814, and housing 1816 are flush with each other, while contact 1822 and insulation 1824 are flush with each other and can move relative to housing 1826.

Contact 1822 and insulation 1824 can move relative to housing 1826 such that contact 1822 can engage contact 1812. Contact assembly 1820 can mate with contact assembly 1810 in a contact direction that is orthogonal or normal to a surface of contact 1822. Alternatively, contact assembly 1820 can slide laterally across contact assembly 1810 (or contact assembly 1810 can slide laterally across contact assembly 1820) until contact 1822 aligns with contact 1812, at which point contact 1822 and insulation 1824 can move towards contact assembly 1810 such that contact 1822 mates with contact 1812.

Where contact assembly 1810 and contact assembly 1820 engage in a normal direction, contact 1812 and contact 1822 might encounter little marring. But when contact assembly 1820 moves laterally across contact assembly 1810 (or contact assembly 1810 slides laterally across contact assembly 1820), contact 1822 can interact with housing 1816 and contact 1812, thereby becoming marred. Similarly, contact 1812 can interact with housing 1826, thereby becoming marred. This marring can lead to scratches. These scratches can expose galvanic connections and galvanic voltages among various plating layers and substrates of contacts 1812 and 1822. These galvanic voltages in the presence of an electrolyte can cause corrosion at the surfaces of contacts 1812 and 1822.

In FIG. 18B, a first device can include contact assembly 1830, which can include contact 1832 surrounded by adjacent insulation 1834 and housing 1836. A second device can include contact assembly 1840, which can include contact 1842 surrounded by adjacent insulation 1844 and housing 1846. In this example, contact 1832, insulation 1834, and housing 1836 are flush with each other, while contact 1842 can include extension 1848 that is proud of insulation 1844. Contact 1842 and insulation 1844 can move relative to housing 1846.

Contact 1842 and insulation 1844 can move relative to housing 1846 such that contact 1842 can engage contact 1832. Contact assembly 1840 can mate with contact assembly 1830 in a contact direction that is orthogonal or normal to a surface of contact 1842. Alternatively, contact assembly 1840 can slide laterally across contact assembly 1830 until contact 1842 aligns with contact 1832, at which point contact 1842 and insulation 1844 can move towards contact assembly 1830 such that contact 1842 mates with contact 1832.

Where contact assembly 1830 and contact assembly 1840 engage in a normal direction, contact 1832 and contact 1842 might encounter little marring. But when contact assembly 1840 moves laterally across contact assembly 1830 (or contact assembly 1830 slides laterally across contact assembly 1840), contact 1842 extension 1848 can interact with housing 1836 and contact 1832, thereby becoming marred. Similarly, contact 1832 can interact with housing 1846, thereby becoming marred. This marring can lead to scratches. These scratches can expose galvanic connections and galvanic voltages among various plating layers and substrates of contacts 1832 and 1842. These galvanic voltages in the presence of an electrolyte can cause corrosion at the surfaces of contacts 1832 and 1842.

In FIG. 18C, a first device can include contact assembly 1850, which can include contact 1852 surrounded by adjacent insulation 1854 and housing 1856. A second device can include contact assembly 1860, which can include contact 1862 surrounded by adjacent insulation 1864 and housing 1866. In this example, contact 1852 can be recessed relative to housing 1856, while insulation 1854 can be further recessed relative to housing 1856. Contact 1862 can include extension 1868 that is proud of housing 1866, while insulation 1864 can include extension 1869 that is proud of both housing 1866 and contact 1862. Contact 1862 and insulation 1864 can move relative to housing 1866.

Contact 1862 and insulation 1864 can move relative to housing 1866 such that contact 1862 can engage contact 1852. Contact assembly 1860 can mate with contact assembly 1850 in a contact direction that is orthogonal or normal to a surface of contact 1862. Alternatively, contact assembly 1860 can slide laterally across contact assembly 1850 until contact 1862 aligns with contact 1852, at which point contact 1862 and insulation 1864 can move towards contact assembly 1850 such that contact 1862 mates with contact 1852.

Where contact assembly 1850 and contact assembly 1860 engage in a normal direction, contact 1852 and contact 1862 might encounter little marring. When contact assembly 1860 moves laterally across contact assembly 1850 (or contact assembly 1850 slides laterally across contact assembly 1860), contact 1852 extension 1858 can interact with insulation 1864 extension 1869, which might not cause significant marring. Contact 1862 extension 1868 can be protected by insulation 1864 extension 1869, thereby reducing any marring of contact 1862.

In FIG. 18D, a first device can include contact assembly 1870, which can include contact 1872 surrounded by adjacent insulation 1874 and housing 1876. A second device can include contact assembly 1880, which can include contact 1882 surrounded by adjacent insulation 1884 and housing 1886. In this example, contact 1872 can be recessed relative to housing 1876, while insulation 1874 can be further recessed relative to housing 1876. Contact 1882 can be flush with insulation 1884, which can both be recessed relative to housing 1886. Contact 1882 and insulation 1884 can move relative to housing 1886.

Contact 1882 and insulation 1884 can move relative to housing 1886 such that contact 1882 can engage contact 1872. Contact assembly 1880 can mate with contact assembly 1870 in a contact direction that is orthogonal or normal to a surface of contact 1882. Alternatively, contact assembly 1880 can slide laterally across contact assembly 1870 until contact 1882 aligns with contact 1872, at which point contact 1882 and insulation 1884 can move towards contact assembly 1870 such that contact 1882 mates with contact 1872. This movement can be facilitated by magnets 1879 in contact assembly 1870 and magnets 1889 in contact assembly 1880.

Where contact assembly 1870 and contact assembly 1880 engage in a normal direction, contact 1872 and contact 1882 might encounter little marring. When contact assembly 1880 moves laterally across contact assembly 1870 (or contact assembly 1870 slides laterally across contact assembly 1880), contact 1872 extension 1878 might not interact with contact assembly 1880 and might avoid being marred. Contact 1882 can be recessed and protected by insulation 1884, thereby avoiding marring.

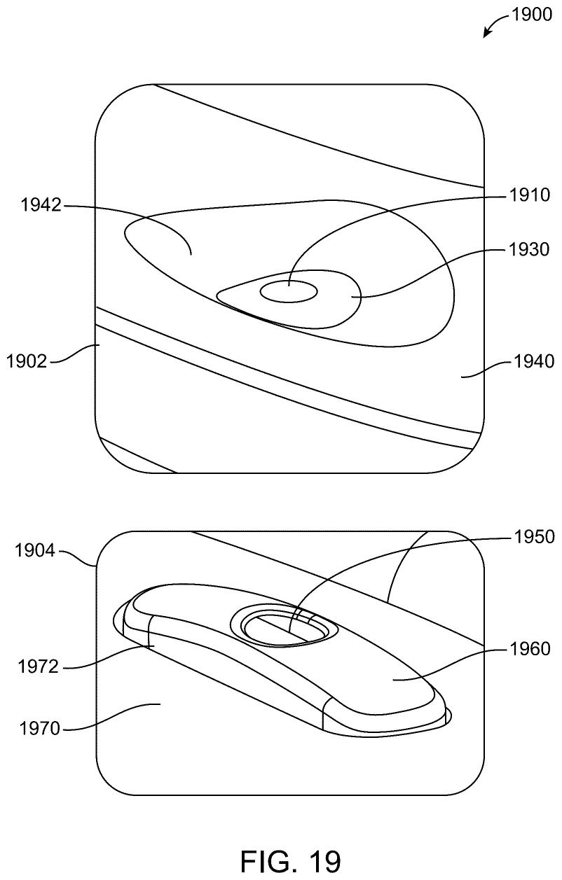

FIG. 19 illustrates contact assemblies for a contact interface according to an embodiment of the present invention. A first electronic device 1902 and a second electronic device 1904 can form electronic system 1900. First electronic device 1902 can include a contact assembly including contact 1910 supported by insulation 1930. Contact 1910 and insulation 1930 can be located in a recess 1942 in enclosure 1940 of first electronic device 1902.

Second electronic device 1904 can include a contact assembly including contact 1950 supported by insulation 1960. Contact 1950 and insulation 1960 can be located in opening 1972 in enclosure 1970 of second electronic device 1904. Contact 1950 and insulation 1960 can move to be positioned in recess 1942 of enclosure 1940 of first electronic device 1902 when contact 1910 in first electronic device is mated with contact 1950 in second electronic device 1904.

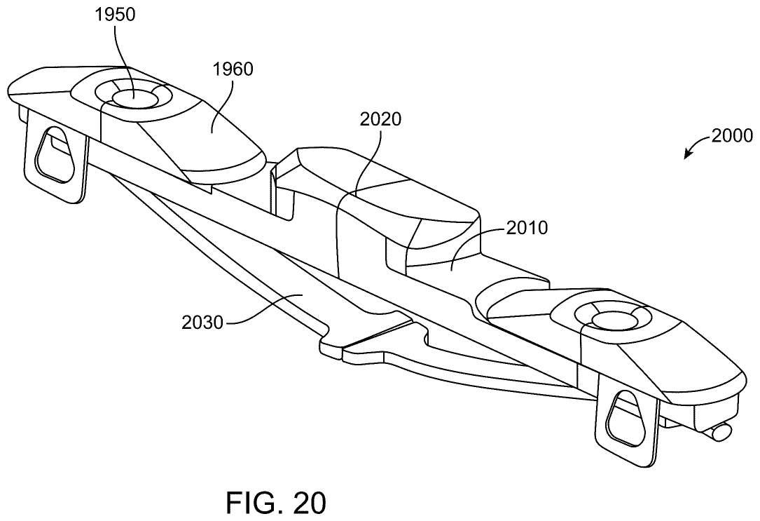

FIG. 20 illustrates further details of a contact assembly according to an embodiment of the present invention. Contact assembly 2000 can include two contacts 1950, each supported by an insulation 1960. Insulations 1960 can be supported by beam 2010. Beam 2010 can be driven by springs 2030 such that contacts 1950 can engage contacts 1910 (shown in FIG. 19.) Beam 2010 can be depressed by aligning portion 2020. Aligning portion 2020 can align with a recess in first electronic device 1902 (shown in FIG. 19), allowing springs 2030 to push contacts 1950 into engagement with contacts 1910.

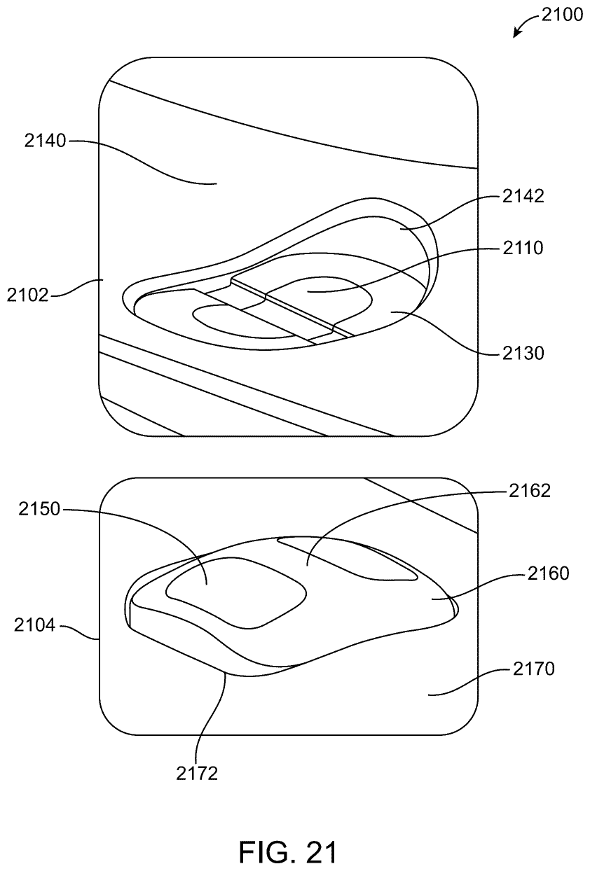

FIG. 21 illustrates contact assemblies for a contact interface according to an embodiment of the present invention. A first electronic device 2102 and a second electronic device 2104 can form electronic system 2100. First electronic device 2102 can include a contact assembly including contact 2110 supported by insulation 2130. Contact 2110 and insulation 2130 can be located in a recess 2142 in enclosure 2140 of first electronic device 2102.

Second electronic device 2104 can include a contact assembly including contact 2150 supported by insulation 2160. Contact 2150 and insulation 2160 can be located in opening 2172 in enclosure 2170 of second electronic device 2104. Contact 2150 and insulation 2160 can move to be positioned in recess 2142 of enclosure 2140 of first electronic device 2102 when contact 1910 in first electronic device is mated with contact 1950 in second electronic device 1904.

Contact 2150 can include two contacting portions separated by an insulation portion 2162. Insulation portion 2162 can be a surface that can be exposed to wear in order to protect the exposed regions of contact 2150. Similar to insulation 1864 extensions 1869 (shown in FIG. 18C), insulation portion 2162 can engage enclosure 2140 and contact 2110 of first electronic device 2102 as first electronic device 2102 and second electronic device 2104 move laterally across each other during mating.

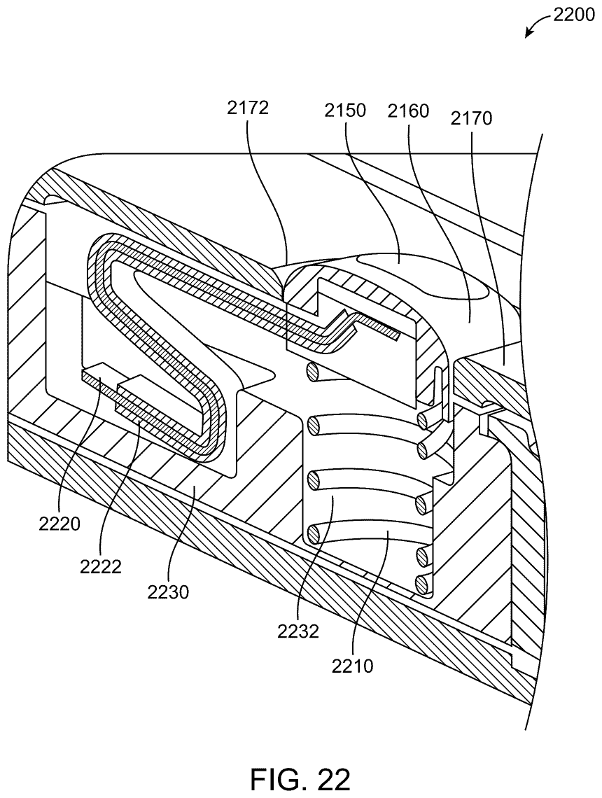

FIG. 22 is a cutaway side view of a contact assembly according to an embodiment of the present invention. Contact assembly 2200 can include contact 2150, which can be supported by insulation 2160. Contact 2150 and insulation 2160 can be positioned in opening 2172 of enclosure 2170. Enclosure 2170 can be over housing 2230. Housing 2230 can include hole 2232 for spring 2210. Spring 2210 can be compressed as first electronic device 2102 and second electronic device 2104 (both shown in FIG. 21) move laterally across each other during mating. Spring 2210 can push contact 2150 into contact 2110 when contact 2150 and insulation 2160 align with recess 2142 of enclosure 2140 (both shown in FIG. 21.) Signals received and provided on contact 2150 can be conveyed by conductor 2220. Conductor 2220 can be insulated with insulation 2222.

Embodiments of the present invention can incorporate various features to limit or reduce galvanic corrosion of contacts of electronic devices. For example, the materials used on the contacts and housing can be selected to avoid differences in their galvanic voltages. Other DC voltages, such as DC offsets in the AC waveforms used to transfer power, can be avoided or adjusted to cancel galvanic voltages between materials used. DC conduction paths can also be blocked to limit electrochemical reactions that can lead to corrosion. Examples are shown in the following figures.

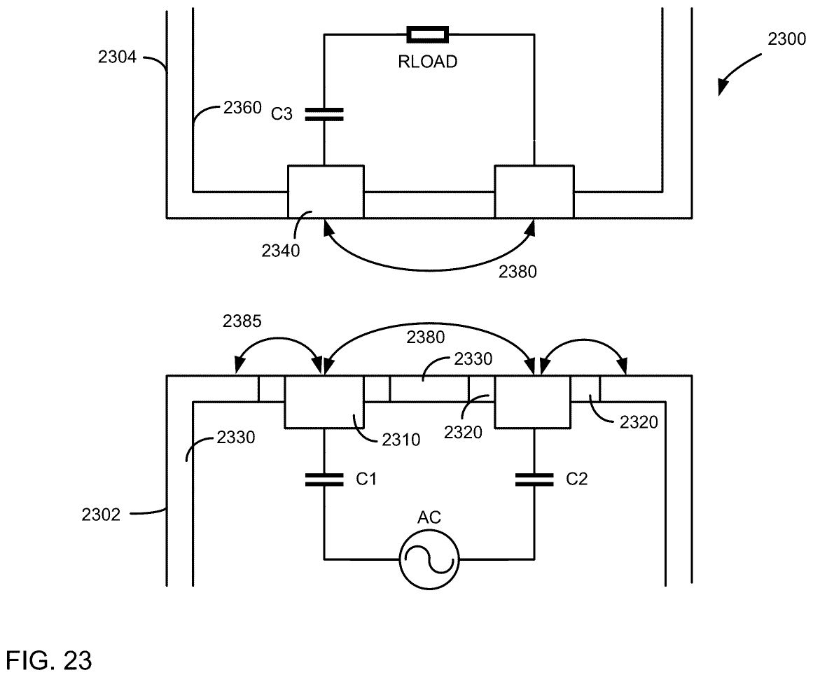

FIG. 23 illustrates galvanic corrosion paths in electronic devices according to embodiments of the present invention. Electronic system 2300 can include first electronic device 2302 and second electronic device 2304. First electronic device 2302 can provide AC power through capacitor C1 and capacitor C2 and contacts 2310. Contacts 2310 can be insulated by insulation 2320 and supported by housing 2330.

In this example, ionic pathways can exist between contacts 2310 and housing 2330. For example, ionic pathway 2380 can exist between contacts 2310. Ionic pathways 2385 can exist between each contact 2310 and housing 2330. The AC nature of the waveforms delivered on contacts 2310 can alternate quickly enough to limit any electrochemical reactions. However, the presence of any DC currents, whether based on a galvanic voltage, an offset in the AC waveforms, or otherwise, can cause electrochemical reactions that can lead to corrosion.

Accordingly, as shown above in FIG. 10, DC blocking capacitor C1 and blocking capacitor C2 can be placed in series between internal circuitry of first electronic device 2302 and contacts 2310. Capacitor C1 and capacitor C2 can block DC currents that could otherwise result in electrochemical reactions that could lead to corrosion.

These and other embodiments of the present invention can further limit corrosion by further reducing electric fields among contacts 2310 and housing 2330. For example, the materials chosen for contacts 2310, including materials for any plating and housing 2330, can be selected to reduce any galvanic voltages. As an example, contacts 2310 can be plated with gold, having a galvanic voltage range of 0.07 to 0.2V, while the housing can be titanium, having a galvanic voltage range of −0.12 to 0.04V.

These and other embodiments of the present invention can further reduce galvanic voltage differences by selecting a non-conductive material for a housing. For example, second electronic device 2304 can include contacts 2340 supported by housing 2360. Contacts 2340 can be metallic regions formed or plated on housing 2360. Housing 2360 can be a nonconductive material, such as plastic, ceramic, or a combination of these or other materials.

The selection of a nonconductive material for housing 2360 can reduce the ionic pathways to pathway 2380, which is between contacts 2340. As a result, only one capacitor, shown here as capacitor C3, might be needed block DC current flowing through pathway 2380. Using the one capacitor might be more likely in a power receiving device, where asymmetries caused by the lack of a second capacitor in a power delivery device are not relevant.

In these and other embodiments of the present invention, it can be desirable that the capacitors used, such as capacitor C1, capacitor C2, and capacitor C3 fail in the open state in order to prevent a DC current path from forming. Accordingly, “Y” type capacitors that fail open can be used as capacitor C1, capacitor C2, and capacitor C3.

Electrolytes are not always present in these and other types of electronic systems. Often, contacts 2310 or other contacts are dry and free from liquids or other electrolytes. In such a circumstance, power can be saved by transferring power in a DC manner. For example, inverter/rectifier circuit 1030 and inverter/rectifier circuit 1040 (both shown in FIG. 10) can be bypassed. An example is shown in the following figure.

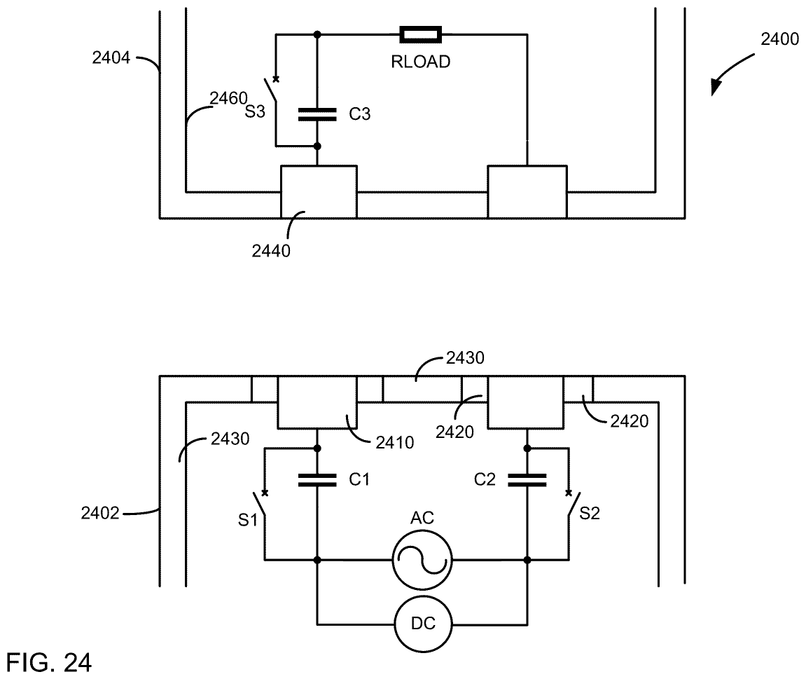

FIG. 24 illustrates optional DC charging in electronic devices according to embodiments of the present invention. Electronic system 2400 can include first electronic device 2402 and second electronic device 2404. In first electronic device 2402, contacts 2410 can be insulated by insulation 2420 and supported by housing 2430. In second electronic device 2404, contacts 2440 can be supported by, or plated on, nonconductive housing 2460.

First electronic device 2402 can provide AC power through capacitor C1 and capacitor C2 and contacts 2310. First electronic device 2402 can provide DC power through closed switch S1 that can bypass capacitor C1 and through closed switch S2 that can bypass capacitor C2, thereby connecting contacts 2410 to the DC source. Similarly, second electronic device 2404 can receive power through capacitor C3 and can receive DC power by bypassing capacitor C3 with switch S3.

It can be desirable that switch S1, switch S2, and switch S3 have a very high open impedance to prevent DC leakage in the presence of an electrolyte at contacts 2410 and contacts 2440. Accordingly, embodiments of the present invention can use micro relays, micro-mechanical switches, or other types of switches. It should also be noted that many of the design considerations described herein might not provide a contact optimized for DC power transfers and that further compromises might need to be made.

Switch S1, switch S2, and switch S3 can each be controlled by first electronic device 2402 or by second electronic device 2404. Switch S1 and switch S2 can be controlled by first electronic device 2402, while switch S3 can be controlled by second electronic device 2404, or these switches can be controlled by other circuits. For example, first electronic device 2402 can determine that contacts 2410 and contacts 2440 are not exposed to electrolytes and can close switch S1, switch S2, and switch S3 before delivering DC power. Second electronic device 2404 can determine that contacts 2410 and contacts 2440 are not exposed to electrolytes and can close switch S1, switch S2, and switch S3 before requesting DC power from first electronic device 2402.

Again, embodiments of the present invention can take measures to reduce or cancel DC electric fields or DC voltages at contacts of electronic devices. These measures can reduce galvanic voltages as described above. They can also involve reducing DC offsets of the AC waveforms used in transferring data. They can also involve using a DC offset of the AC waveforms to cancel remaining galvanic voltages. They can also involve using a DC offset of the AC waveforms that have been empirically or otherwise found to provide reduced corrosion. An example of such as waveform is shown in the following figure.

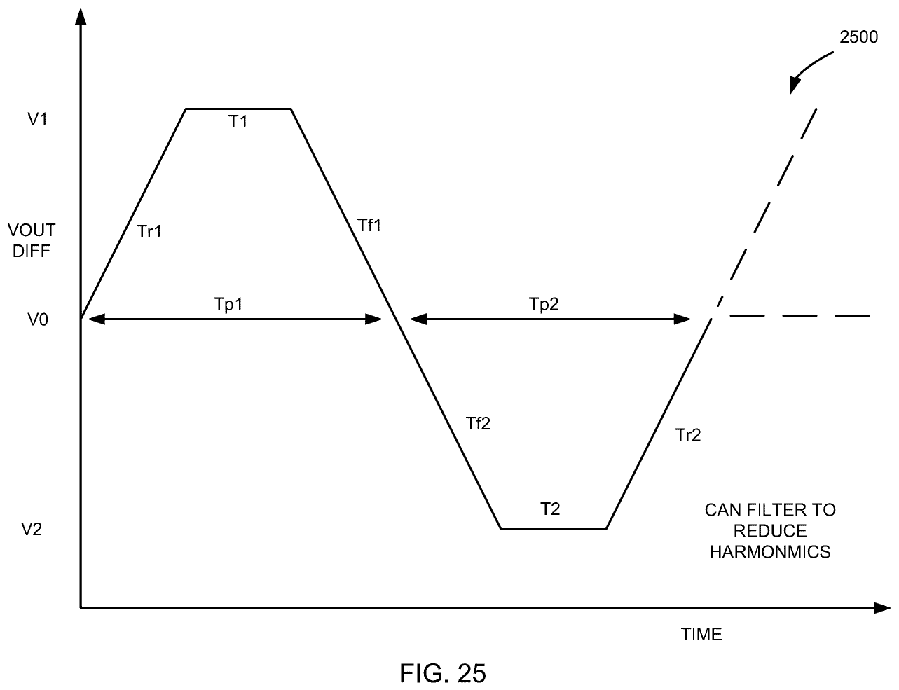

FIG. 25 illustrates a differential AC waveform for power transfers according to an embodiment of the present invention. Waveform 2500 can have a low voltage V2, a high voltage V1, and an average voltage V0. Waveform 2500 can have a rise time from V0 to V1 of Tr1 and can remain at V1 for a time T1. Waveform 2500 can have a fall time from V1 to V0 of Tf1 and a fall time from V0 to V2 of Tf2. Waveform 2500 can remain at V2 for a time T2. Waveform 2500 can have a rise time from V2 to V0 of Tr2. Waveform 2500 can have a positive pulse width of Tp1 and a negative pulse width of Tp2. Filtering can be used to reduce the amount of harmonics present in the AC waveform 2500.

Some or all of these rise times, fall times, high and low levels, and other parameters can be adjustable. For example, the average voltage V0 can be varied. The average voltage V0 can be adjusted to be near zero to reduce any DC voltages generated by the differential AC waveform 2500. The average voltage V0 can instead be adjusted to a level to cancel or compensate for a galvanic voltage present at the power transferring contacts. The average voltage V0 can instead be adjusted to a level that has been empirically or otherwise found to provide reduced corrosion at the power transferring contacts. An example of circuitry and methods that can be used are shown in the following figures.

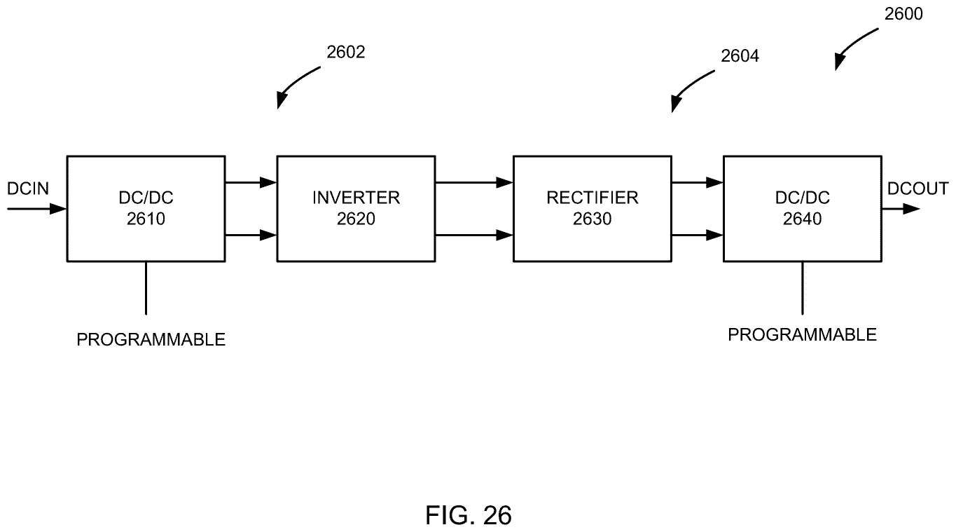

FIG. 26 illustrates a charging path through an electronic system according to an embodiment of the present invention. In this example, a first electronic device 2602 can provide power to a second electronic device 2604 in electronic system 2600. DC-to-DC converter 2610 can receive a DC input voltage DCIN, which can be a battery or other voltage. DC-to-DC converter 2610 can set the high voltage V1 and the low voltage V2 (shown in FIG. 25) for the AC waveforms to be provided from inverter 2620 in first electronic device 2602 to rectifier 2630 in second electronic device 2604. Rectifier 2630 can provide an output to DC-to-DC converter 2640, which can provide an output voltage DCOUT.

In this example, the voltages V1 and V2 can be programmable. The voltages V1 and V2 can be programmed such that the average voltage V0 (shown in FIG. 25) is near zero to reduce any DC voltages generated by the differential AC waveform 2500. V1 and V2 can instead be programmed such that the average voltage V0 can be adjusted to a level to cancel or compensate for a galvanic voltage present at the power transferring contacts. V1 and V2 can instead be programmed to provide an average voltage V0 that has been empirically or otherwise found to minimize corrosion.

In this example, the voltage V1 and voltage V2 can be provided in an open-loop manner. In these and other embodiments of the present invention, the voltage V1 and voltage V2 can be provided in a closed-loop manner. Examples are shown in the following figures.

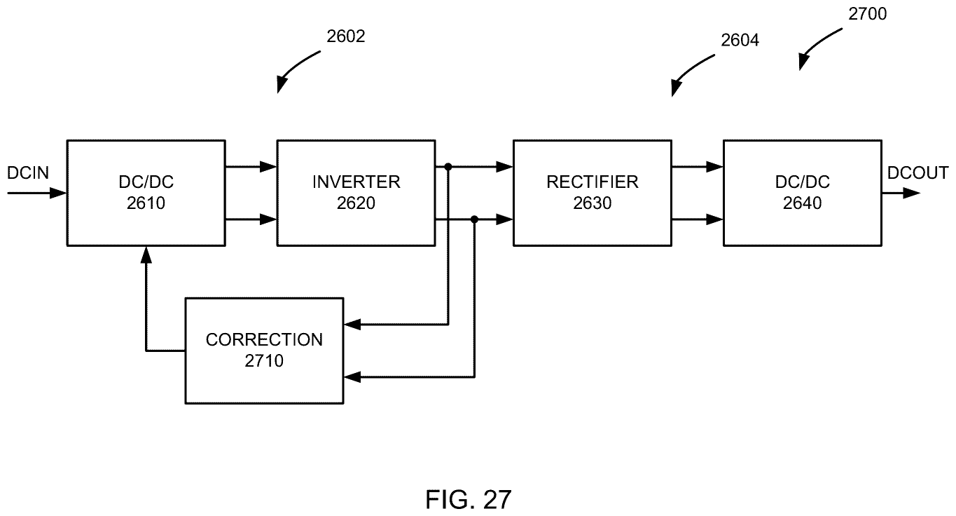

FIG. 27 illustrates another charging path through an electronic system according to an embodiment of the present invention. In this example, a first electronic device 2602 can provide power to a second electronic device 2604 in electronic system 2600. DC-to-DC converter 2610 can receive a DC input voltage DCIN, which can be a battery or other voltage. DC-to-DC converter 2610 can set the high voltage V1 and the low voltage V2 (shown in FIG. 25) for the AC waveforms to be provided from inverter 2620 in first electronic device 2602 to rectifier 2630 in second electronic device 2604. Rectifier 2630 can provide an output to DC-to-DC converter 2640, which can provide an output voltage DCOUT.

In this example, the voltage V1 and the voltage V2 can be adjusted by a feedback path including correction circuit 2710 in first electronic device 2602. The voltage V1 and the voltage V2 at the power transferring contacts of inverter 2620 can be detected and provided to correction circuit 2710. The voltages V1 and V2 can be adjusted by correction circuit 2710 such that the average voltage V0 (shown in FIG. 25) is near zero to reduce any DC voltages generated by the differential AC waveform 2500. V1 and V2 can instead be adjusted by correction circuit 2710 such that the average voltage V0 can be adjusted to a level to cancel or compensate for a galvanic voltage present at the power transferring contacts. V1 and V2 can instead be adjusted by correction circuit 2710 to provide an average voltage V0 that has been empirically or otherwise found to minimize corrosion. Correction circuit 2710 can be used to integrate the positive and negative pulses of the waveform 2500 to adjust the average voltage V0.

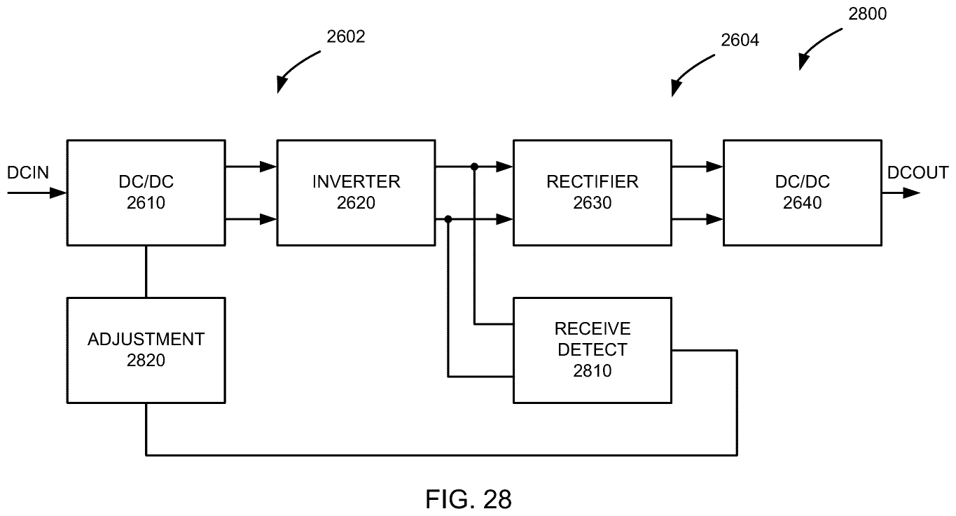

FIG. 28 illustrates another charging path through an electronic system according to an embodiment of the present invention. In this example, a first electronic device 2602 can provide power to a second electronic device 2604 in electronic system 2600. DC-to-DC converter 2610 can receive a DC input voltage DCIN, which can be a battery or other voltage. DC-to-DC converter 2610 can set the high voltage V1 and the low voltage V2 (shown in FIG. 25) for the AC waveforms to be provided from inverter 2620 in first electronic device 2602 to rectifier 2630 in second electronic device 2604. Rectifier 2630 can provide an output to DC-to-DC converter 2640, which can provide an output voltage DCOUT.

In this example, the voltage V1 and the voltage V2 can be adjusted by a feedback path including receive detect circuit 2810 in second electronic device 2604 and adjustment circuit 2820 in first electronic device 2602. This can be done is various ways. In one example, the voltage V1 and the voltage V2 at the power receiving contacts of rectifier 2630 can be detected by receive detect circuit 2810. This information can be conveyed to adjustment circuit 2820. The voltages V1 and V2 can be adjusted by adjustment circuit 2820 such that the average voltage V0 (shown in FIG. 25) is near zero to reduce any DC voltages generated by the differential AC waveform 2500 (shown in FIG. 25.) In another example, receive detect circuit 2810 can determine an adjustment to be made and can provide that information to adjustment circuit 2820. V1 and V2 can instead be adjusted by adjustment circuit 2820 such that the average voltage V0 can be adjusted to a level to cancel or compensate for a galvanic voltage present at the power transferring contacts. V1 and V2 can instead be adjusted by adjustment circuit 2820 to provide an average voltage V0 that has been empirically or otherwise found to minimize corrosion. Receive detect circuit 2810 can communicate with adjustment circuit 2820 over the power transferring contacts by sending an AC signal at a different frequency as compared to the AC waveform 2500. Receive detect circuit 2810 can communicate with adjustment circuit 2820 over other wired, wireless, or other type of communication channel.

In these and other embodiments of the present invention, know patterns, which can be referred to as training patterns, can be provided by first electronic device 2602 to second electronic device 2604. These known patterns can be used by receive detect circuit 2810 in second electronic device 2604 and adjustment circuit 2820 in first electronic device 2602 in adjusting the AC waveform provided by first electronic device 2602 to second electronic device 2604.

Data can be transferred between first electronic device 2602 to second electronic device 2604 using the AC waveforms. The frequency, phase, amplitude, or other characteristic of the AC waveform can be modulated to convey data. Other signals at other frequencies can be combined with the AC waveform using a diplexer, common-mode choke, or other circuit. The data can be transferred in the same direction as the direction of power transfer, or power and data can be transferred in different directions.

Various aspects of differential AC waveform 2500 can be varied or adjusted based on the materials of the contacts, the materials of the housings, the presence or absence of electrolytes, and the types of any present electrolyte. An example of a method of determining a type of material used in a contact is shown in the following figure.

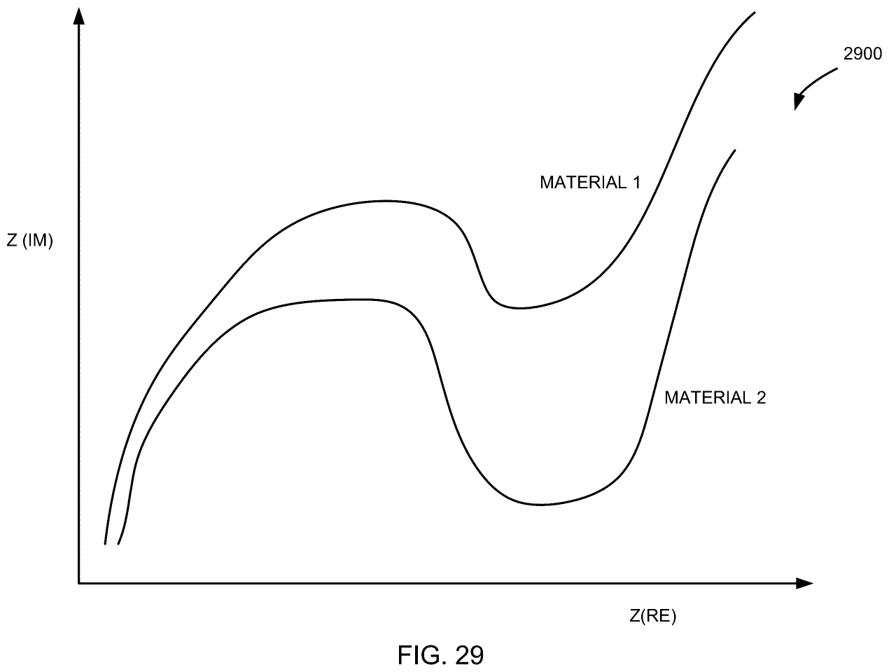

FIG. 29 illustrates data that can be used by a method of determining a type of material used for a contact according to an embodiment of the present invention. In this example, Electrochemical-Impedance Spectroscopy (EIS) curves are generated ahead of time for different materials in the absence of electrolytes. An electronic device can take similar measurements shortly after connection between two electronic devices when the absence of electrolytes might be likely. These measurements can be taken at these and other times where the absence of electrolytes has been determined.

The EIS curve measured by the electronic device can reflect the parallel combination of a contact at the measuring device and a contact of a mated device. The contact at the measuring device can be known and stored during manufacturing. Using the measured EIS curve and the known measuring device material, the contribution to the EIS curve by the parallel mated device contact can be extrapolated. The extrapolated EIS curve of the mated device contact can be compared to premeasured curves, such as those in this figure. From this, the material for the contact of the mated device can be determined. These and other embodiments of the present invention might not generate entire curves. Instead, data points at a few specific frequencies can be used.

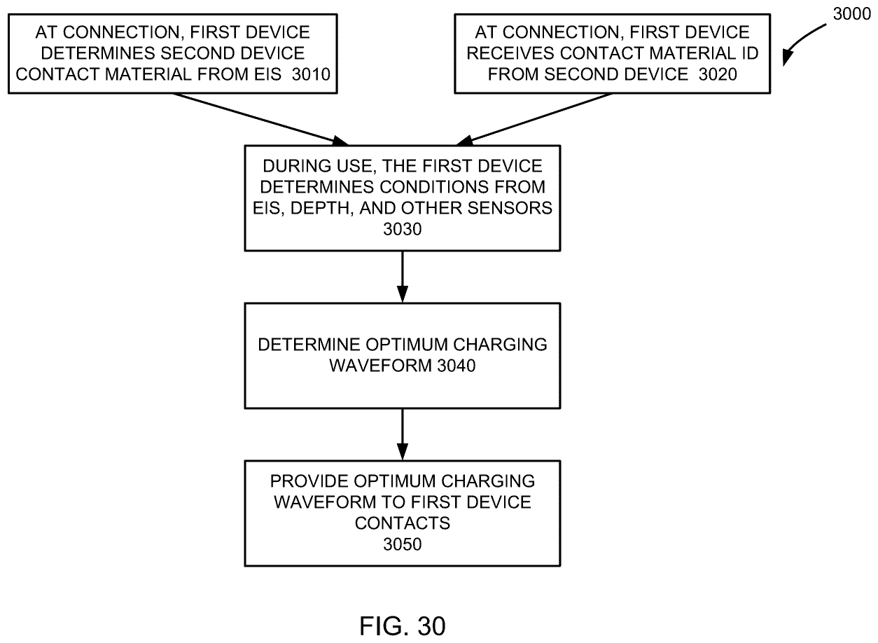

FIG. 30 illustrates a method of optimizing a charging waveform according to an embodiment of the present invention. In act 3010 of method 3000, when a connection is formed, a first device can determine contact material of a second device using EIS. Such a method is outlined in FIG. 29 above. Instead of using EIS, the first device can receive information regarding contact material directly from the second device in act 3020. The first device can gather other information during use. This information can include environmental and other information. For example, the first device can receive EIS updates, depth, and other information from other sensors in act 3030. In act 3040, an optimized charging waveform can be determined. This charging waveform can be provided to contacts of the first device for reception by contacts of the second device in act 3050.

Embodiments of the present invention can provide power delivery circuits and apparatus that can be located in various types of devices, such as portable computing devices, tablet computers, desktop computers, laptops, all-in-one computers, wearable computing devices, cell phones, smart phones, media phones, storage devices, portable media players, navigation systems, monitors, power supplies, video delivery systems, adapters, remote control devices, chargers, and other devices.

Reference numbers are used here in a consistent manner among the various figures.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A method of delivering power from a first electronic device to a second electronic device, the method comprising:
with the first electronic device, determining one or more environmental parameters;
using the one or more environmental parameters to optimize an AC charging waveform; and
providing the optimized AC charging waveform to the second electronic device.

2. The method of claim 1 wherein the one or more environmental parameters comprises the presence of an electrolyte.

3. The method of claim 2 wherein the AC charging waveform is optimized in part by adjusting an average of the AC charging waveform to compensate for a galvanic voltage of the first electronic device.

4. The method of claim 3 wherein the AC charging waveform comprises one of two bandwidth limited antiphase square waves, two antiphase square waves, and two antiphase sinewaves.

5. A power transfer circuit comprising:
a battery;
a switch coupled to the battery;
a boost/buck circuit coupled to the switch;
an inverter/rectifier circuit coupled to the boost/buck circuit;
a first capacitor coupled to a first output of the inverter/rectifier circuit; and
a second capacitor coupled to a second output of the inverter/rectifier circuit;
a first contact coupled to the first capacitor; and
a second contact coupled to the second capacitor.

6. The power transfer circuit of claim 5 wherein the first contact and the second contact are spring-biased contacts.

7. The power transfer circuit of claim 6 wherein the first contact and the second contact each comprise a canted coil spring.

8. The power transfer circuit of claim 6 wherein the first contact and the second contact each comprise a stack of Bellville washers.

9. The power transfer circuit of claim 6 wherein the first contact and the second contact each comprise two stacks of Bellville washers.

10. The power transfer circuit of claim 5 wherein the first contact and the second contact are fixed contacts.

11. The power transfer circuit of claim 5 wherein the switch is configured to disconnect the battery from the boost/buck circuit when the power transfer circuit is not transmitting or receiving power.

12. The power transfer circuit of claim 11 wherein the boost/buck circuit increases the voltage from the battery and provides a high voltage and a low voltage when the power transfer circuit is transmitting power.

13. The power transfer circuit of claim 12 wherein the boost/buck circuit decreases a voltage from inverter/rectifier and provides a charging voltage for the battery when the power transfer circuit is receiving power.

14. The power transfer circuit of claim 13 wherein the inverter/rectifier circuit converts the high voltage and the low voltage from boost/buck circuit to a differential output signal when the power transfer circuit is transmitting power.

15. The power transfer circuit of claim 14 wherein the inverter/rectifier circuit rectifies a differential output signal when the power transfer circuit is receiving power.

16. The power transfer circuit of claim 15 wherein the differential output signal comprises two antiphase sinewaves.

17. The power transfer circuit of claim 15 wherein the differential output signal comprises two antiphase square waves.

18. The power transfer circuit of claim 15 wherein the differential output signal comprises two bandwidth limited antiphase square waves.

19. A power transfer circuit to generate a differential output signal, the power transfer circuit comprising:
a first capacitor coupled to receive a first side of the differential output signal;
a second capacitor coupled to receive a second side of the differential output signal;
a first contact coupled to the first capacitor; and
a second contact coupled to the second capacitor.

20. The power transfer circuit of claim 19 wherein the differential output signal comprises one of two bandwidth limited antiphase square waves, two antiphase square waves, and two antiphase sinewaves.
